(19) United States
(12) Patent Application Publication
(10) Pub. No.: US 2002/0046995 A1
(43) Pub. Date: Apr. 25, 2002

(54) Method for forming microchannels by scanning a laser

(76) Inventors: Yong-Joon Andrew Chang, Cupertino, CA (US); Edward Rea, Palo Alto, CA (US); Mark Gitin, Mountain View, CA (US)

Correspondence Address: STALLMAN & POLLOCK LLP, Suite 290, 121 Spear Steet, San Francisco, CA, 94105, US

(21) Appl. No.: 09/838,922

(22) Filed: Apr. 20, 2001

Related U.S. Application Data
(60) Provisional application No. 60/201,145, filed on May 2, 2000.
(60) Provisional application No. 60/220,319, filed on Jul. 24, 2000.

(51) Int. Cl. B23K 26/38

(52) U.S. Cl. 219/121.69; 219/121.8

(57) ABSTRACT

The present invention relates to forming microchannels with smooth bottoms and walls. In one embodiment smooth microchannels are formed by line-scanning a pulsed solid-state laser beam across a substrate such that there is a high degree of both laser pulse overlap and line overlap. In an alternative embodiment such microchannels are made by employing laser pulses whose spatial profiles have been suitably homogenized.

### PRIORITY

This application claims the benefit of U.S. Provisional Application No. 60/201,145, filed May 2, 2000, and U.S. Provisional Application No. 60/220,319, filed Jul. 24, 2000, both entitled Method for Forming Microchannels by Scanning a Laser.

### FIELD OF THE INVENTION

The present invention relates to a method and apparatus for forming microchannels suitable for practical implementations of a microfluidic device on a substrate using laser ablation.

### BACKGROUND OF THE INVENTION

Microfluidic devices are an emerging technology that is steadily gaining in commercial importance. Over time it has become increasingly apparent that microfluidic devices offer a labor-saving and highly precise alternative to traditional methods for performing many types of chemical and biological analyses. Microfluidic systems have been used or proposed for a wide variety of applications including electrophoresis, chromatographic analysis, cell separations, DNA analysis and sequencing, and pharmaceutical drug assays.

Microfluidic devices generally include one or more chambers joined by microchannels or microgrooves having cross-sectional dimensions in the submillimeter range. The size of a microchannel may be considered to be the diameter of the largest circle that can be fit entirely within the microchannel's cross-section, and is typically on the order of tens of microns or smaller. In making a microfluidic device it is very important that the specified microchannels be formed with smooth bottoms and walls because roughness along the interior of the microchannels can affect fluid flow and potentially disturb the functioning of the device. In the past such microchannels have been made using photolithographic or micromilling techniques. More recently laser ablation has been used to make microchannels. Laser ablation techniques offer a number of advantages for forming such microchannels. For example, laser ablation can achieve comparatively high depth-to-width ratios. Because lasers can be focused and directed with great precision, they are also well-suited to forming the very complex patterns that may be needed to make microfluidic devices.

### SUMMARY OF THE INVENTION

It is an object of the present invention to form microchannels with smooth bottoms and walls. In one embodiment this and other objects are achieved by line-scanning a pulsed solid-state laser beam across a substrate such that there is a high degree of both laser pulse overlap and adjacent scan line overlap. In an alternative embodiment these objects are achieved by homogenizing the spatial profile of the laser pulses of a solid-state laser beam and line-scanning the homogenized beam across a substrate.

### BRIEF DESCRIPTION OF THE FIGURES

FIG. 1A shows a functional block diagram of a first embodiment of the present invention.

FIG. 1B shows a functional block diagram of an alternative embodiment of the present invention.

FIG. 2 shows an example of the manner in which laser pulses may overlap on a target plane as the laser is being scanned.

FIG. 3 shows the percentage of pulse overlap as a function of effective spot size for a line-scan of a laser where the pulse repetition rate is a constant 20 kHz, the scan rate is a constant 200 mm/sec, and the spot size is given in microns.

FIG. 4 illustrates the concept of the effective spot size of a laser beam with a Gaussian profile when the laser ablation threshold is higher than the fluence value corresponding to the 1/e² radius.

Each of FIGS. 5A through 5M is a graph showing a distribution for the total relative intensity of light received as a function of position along a line-scan. In each graph the smaller distributions show the spatial intensity distributions for each of the individual pulses of the line scan that were summed to produce the total light intensity distribution graph. The percentage pulse overlap for these figures varies from 0% to 95%.

Each of FIGS. 6A through 6O is a graph showing a distribution for the total relative intensity of light received as a function of position along a line-scan. In each graph the smaller distributions show the spatial intensity distributions for each of the individual pulses of the line scan that were summed to produce the total light intensity distribution graph. The percentage pulse overlap for these figures varies from 0% to 95%. The spatial intensity distributions for each pulse in the line-scans that were summed to produce these graphs were truncated or set to zero at the 13.5% or 1/e² point.

Each of FIGS. 7A through 7M is a graph showing a distribution for the total relative intensity of light received as a function of position along a line-scan. In each graph the smaller distributions show the spatial intensity distributions for each of the individual pulses of the line scan that were summed to produce the total light intensity distribution graph. The percentage pulse overlap for these figures varies from 0% to 95%. The spatial intensity distributions for each pulse in the line-scans that were summed to produce these graphs were truncated or set to zero at the 50% point.

### DETAILED DESCRIPTION OF THE INVENTION

As noted it is important that the microchannels of a microfluidic device have smooth bottoms and walls because roughness can affect the flow of the different chemical species undergoing analysis and potentially disturb the functionality of the device. As such, forming microchannels using a pulsed laser poses a unique technical challenge.

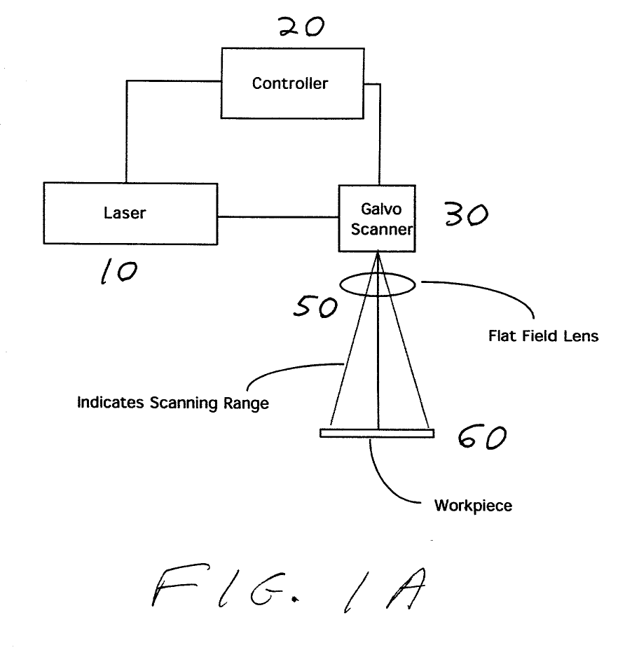

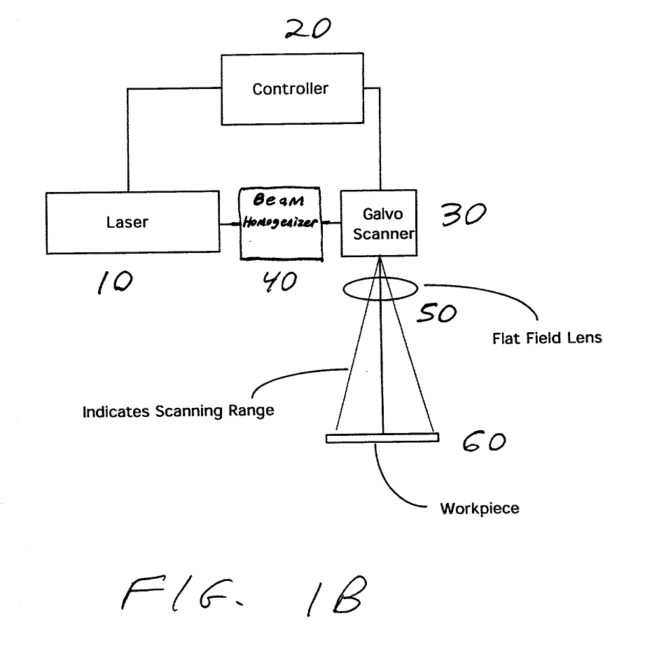

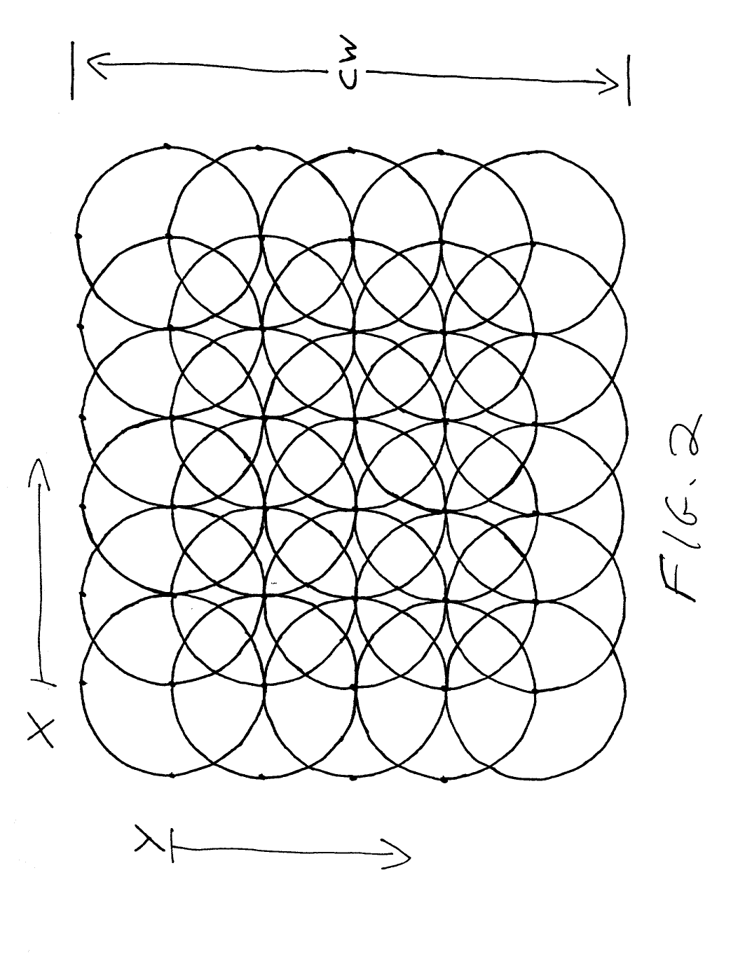

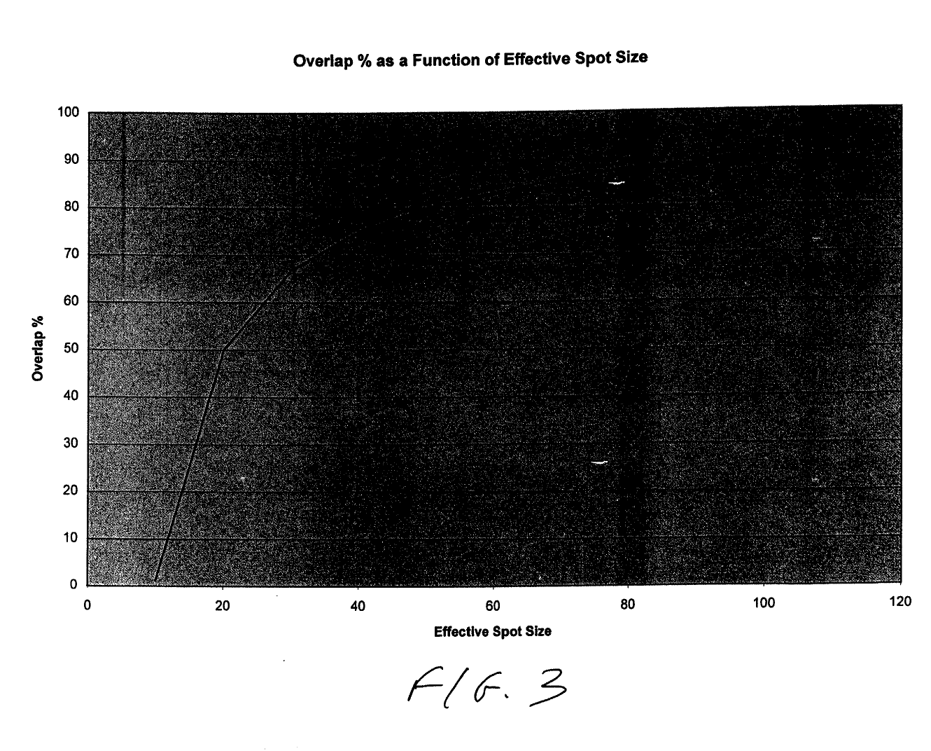

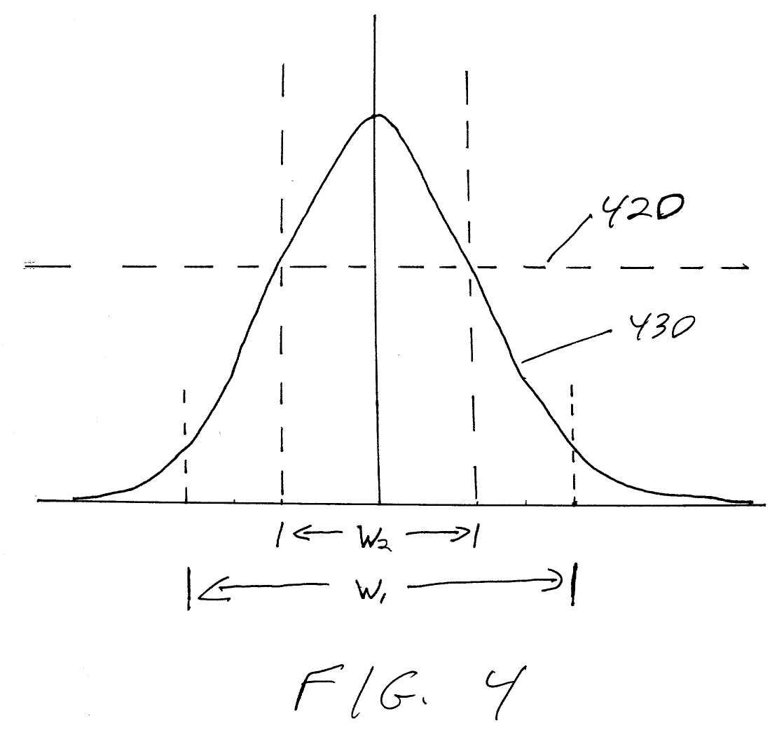

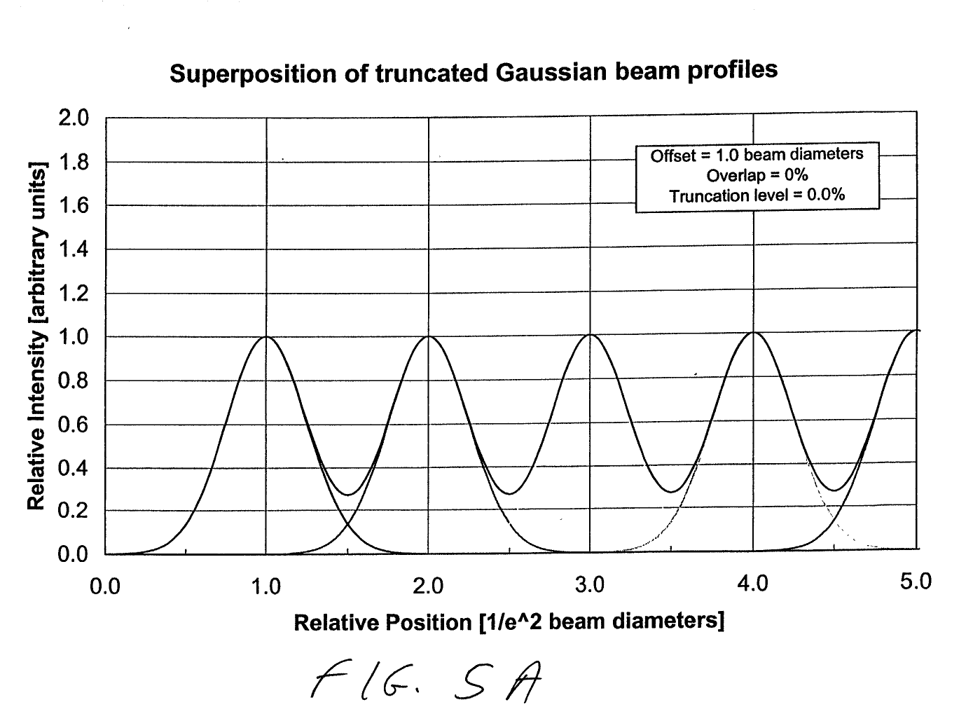

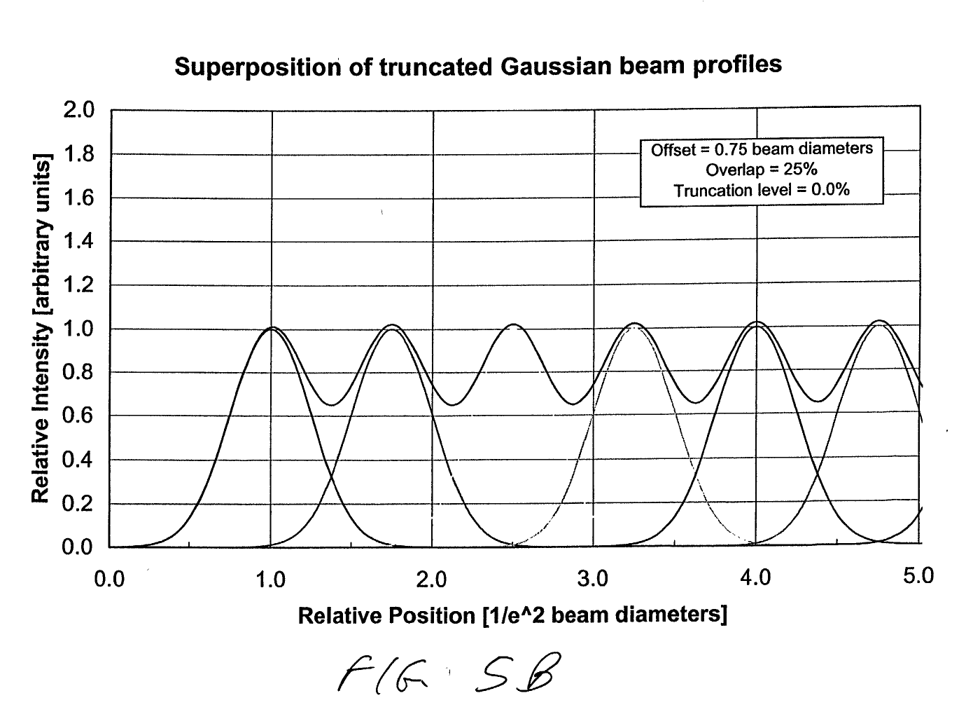

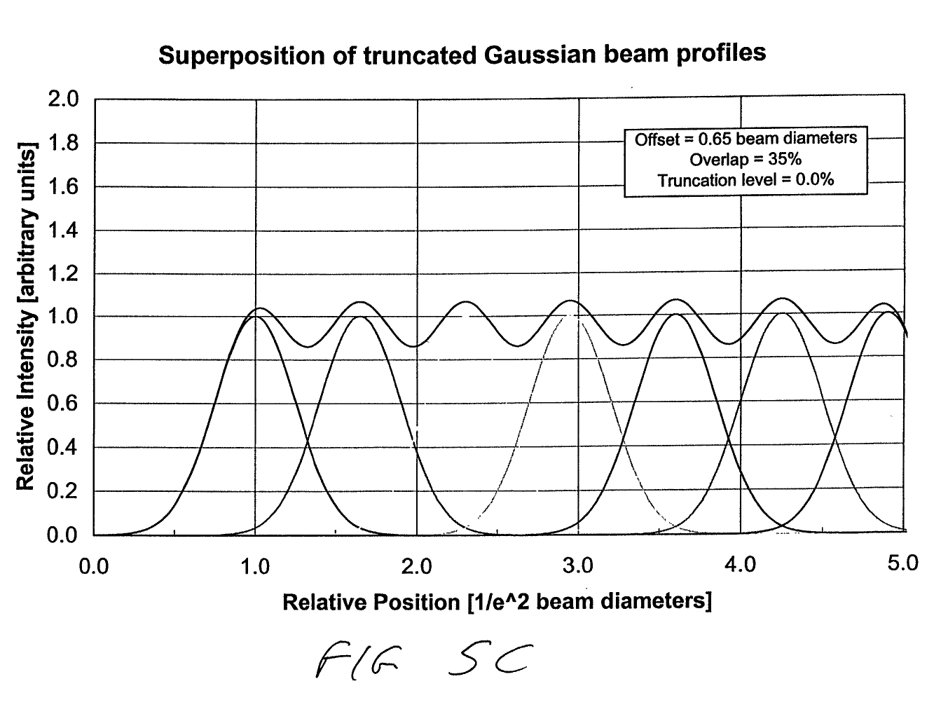

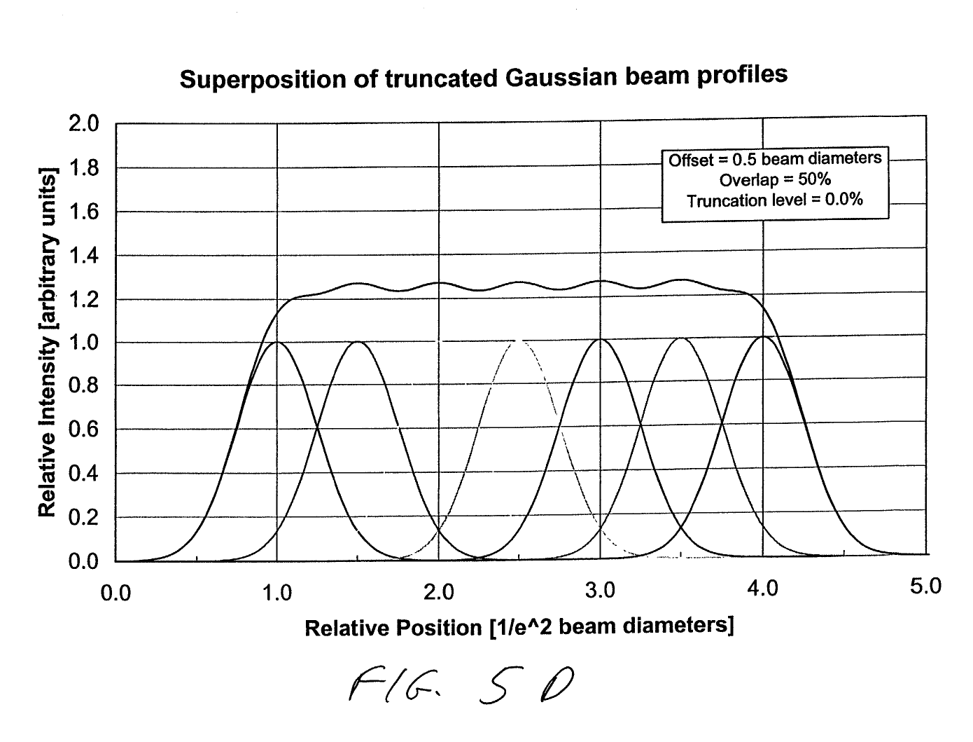

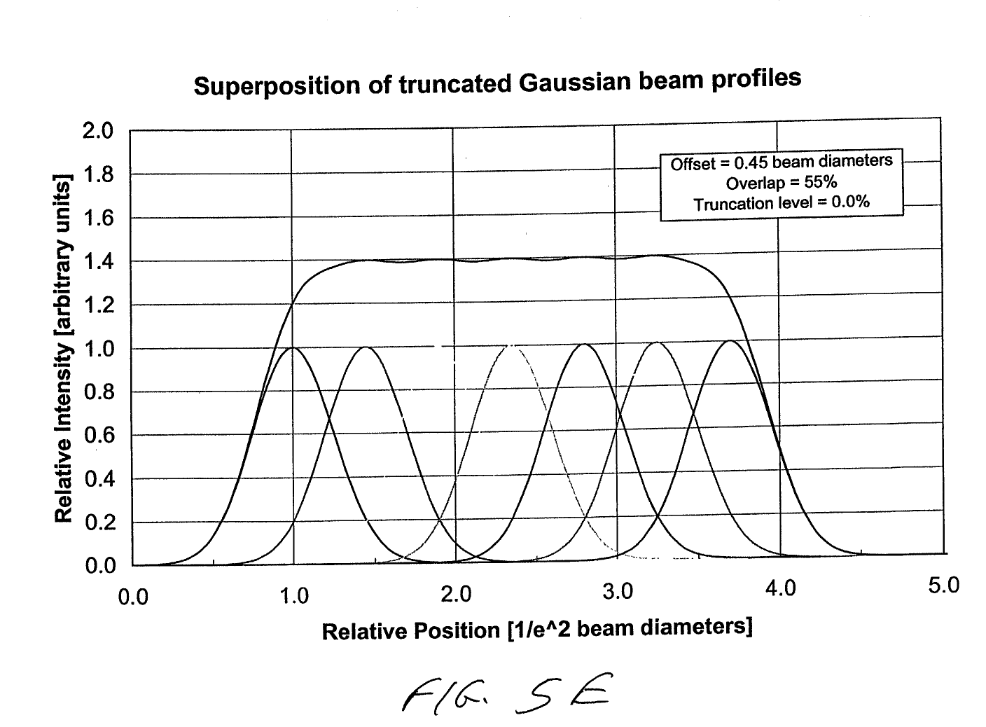

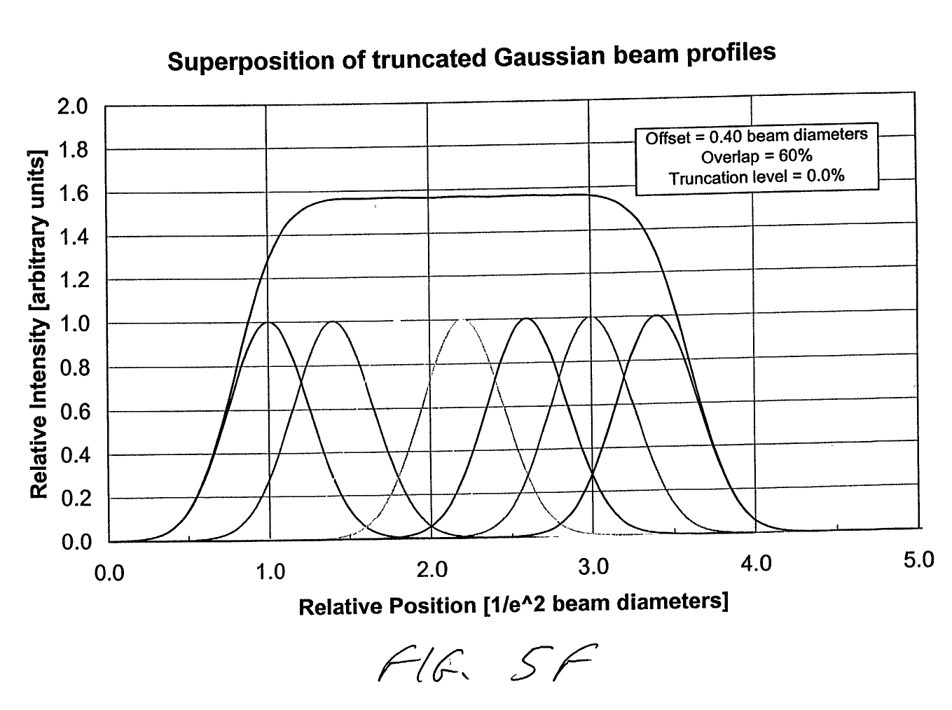

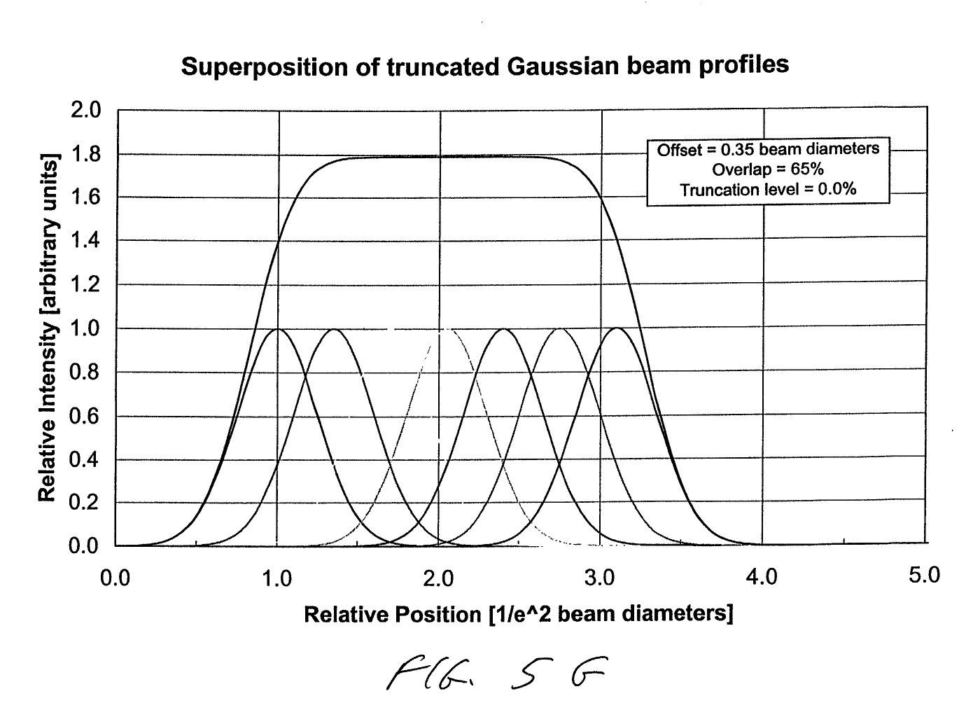

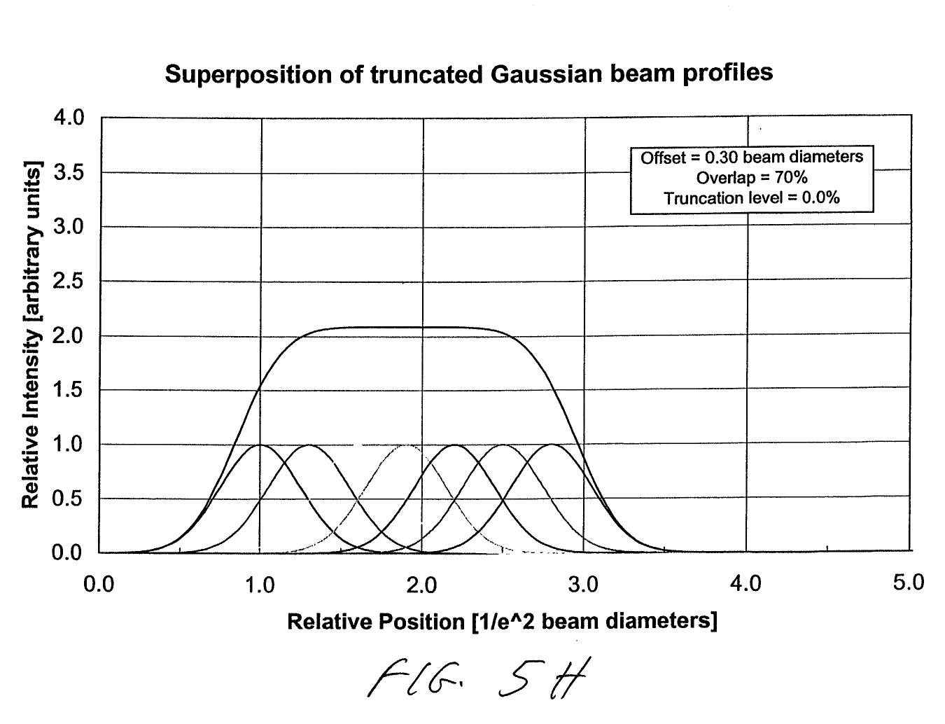

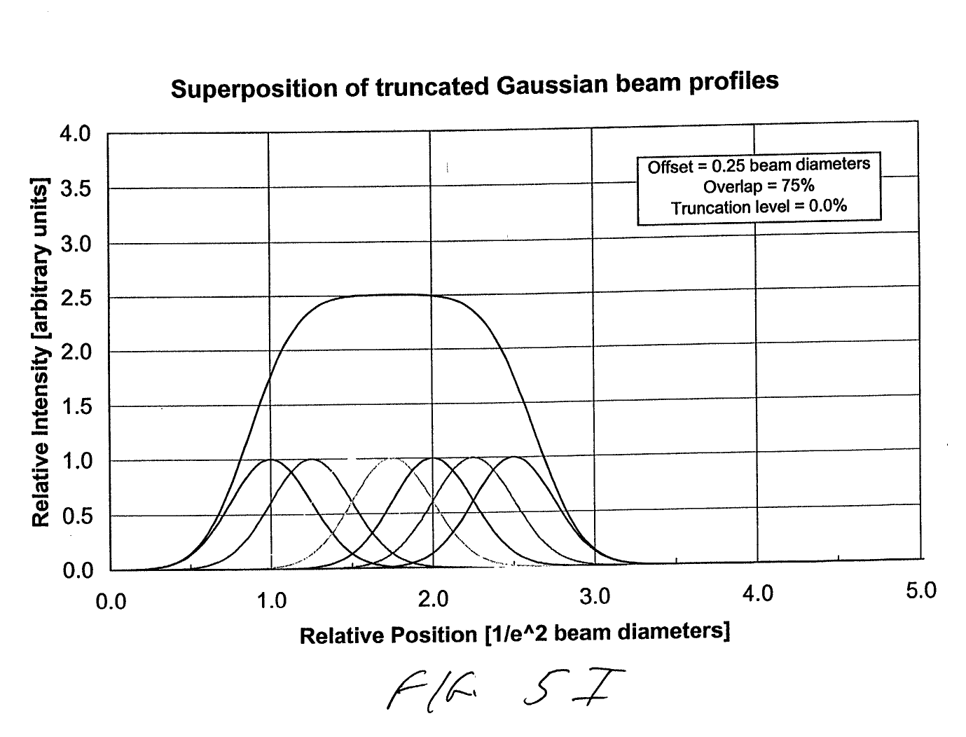

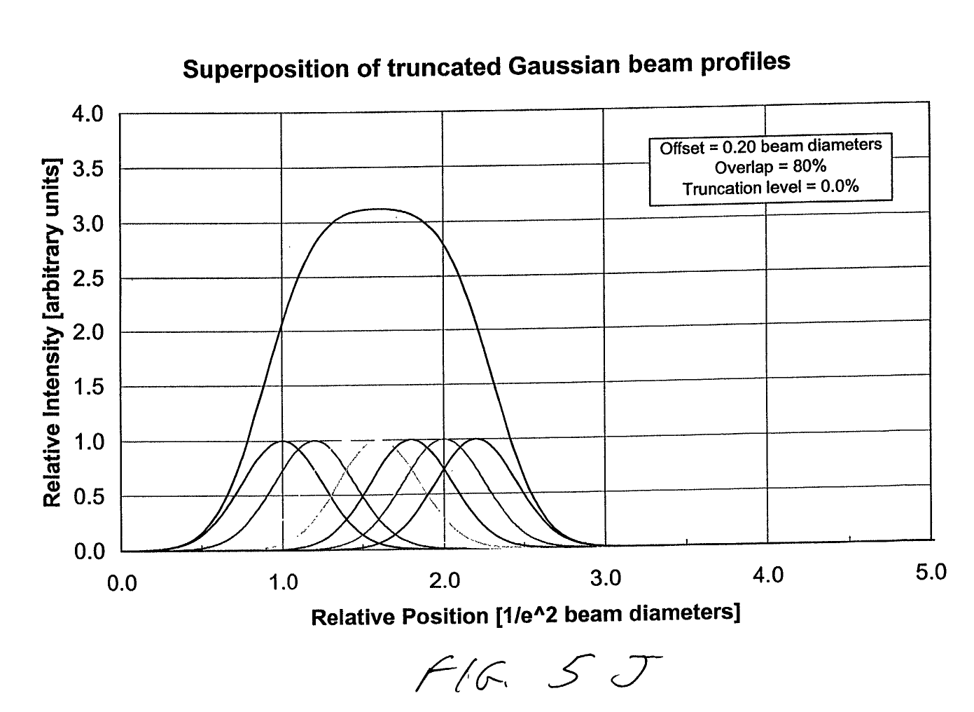

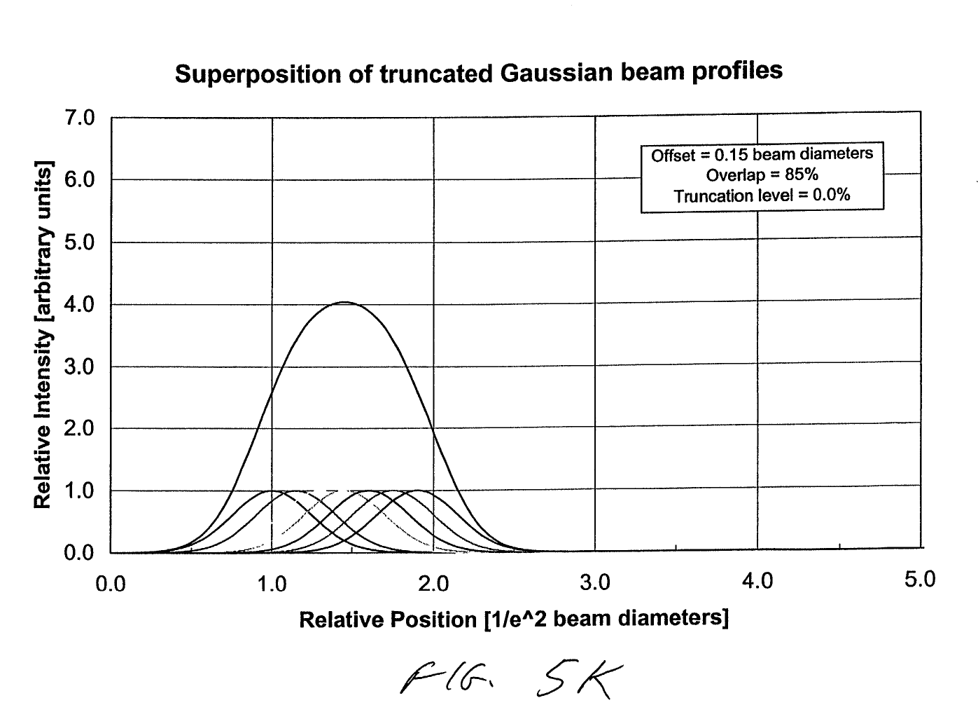

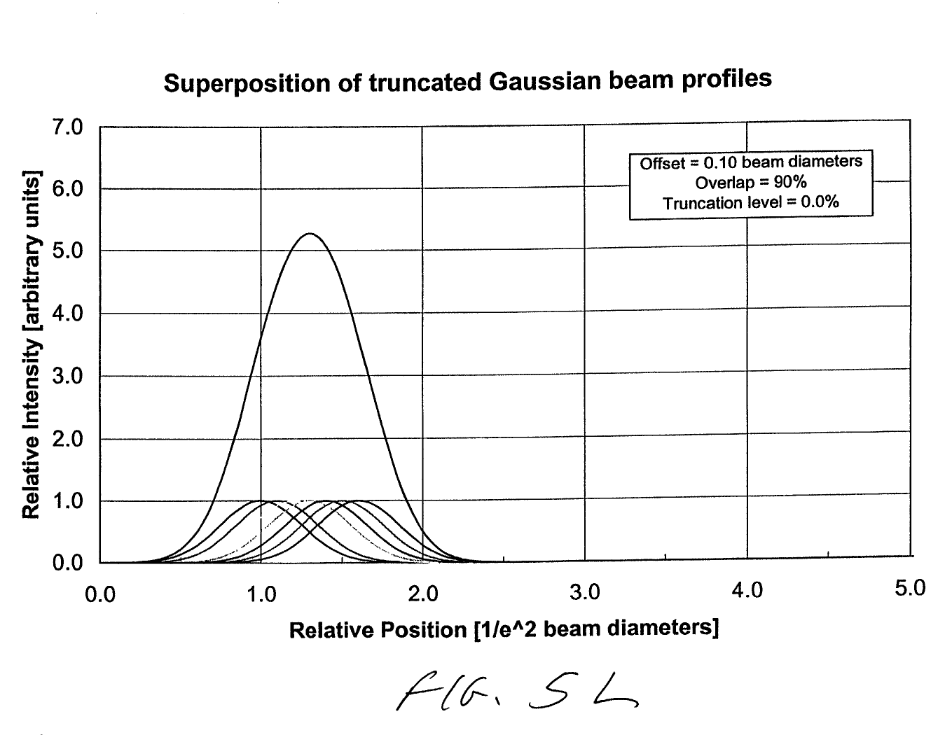

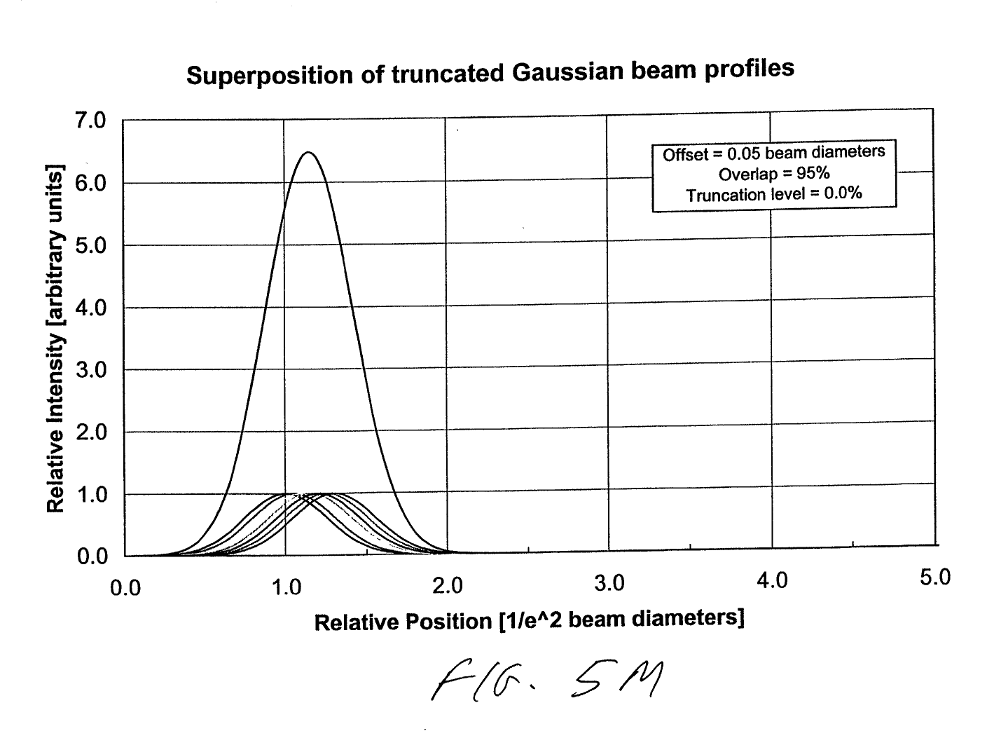

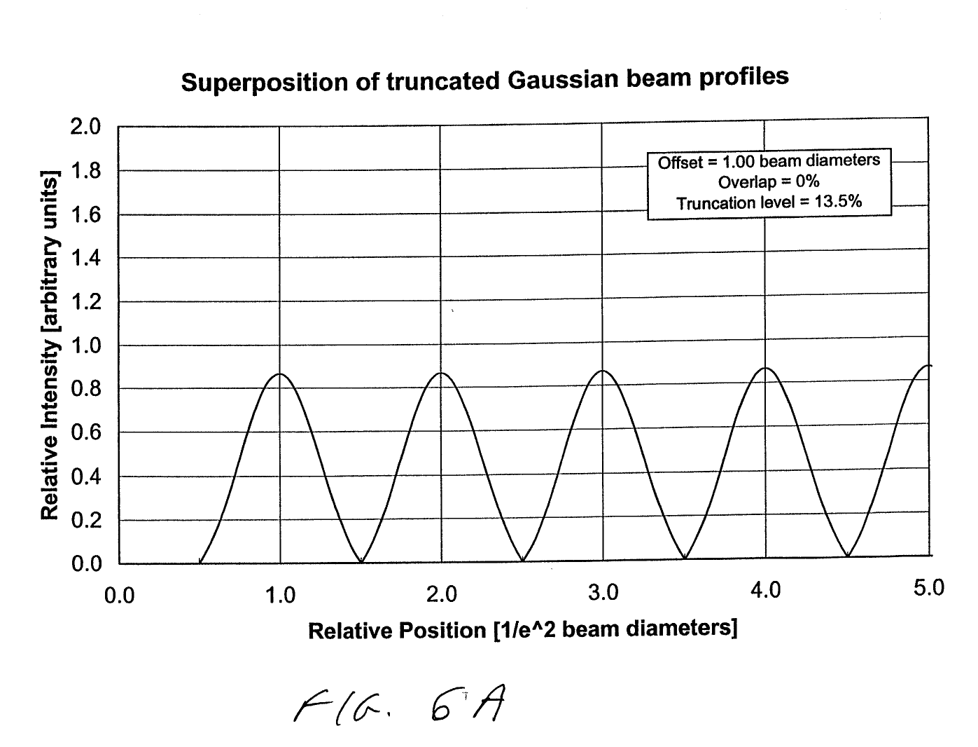

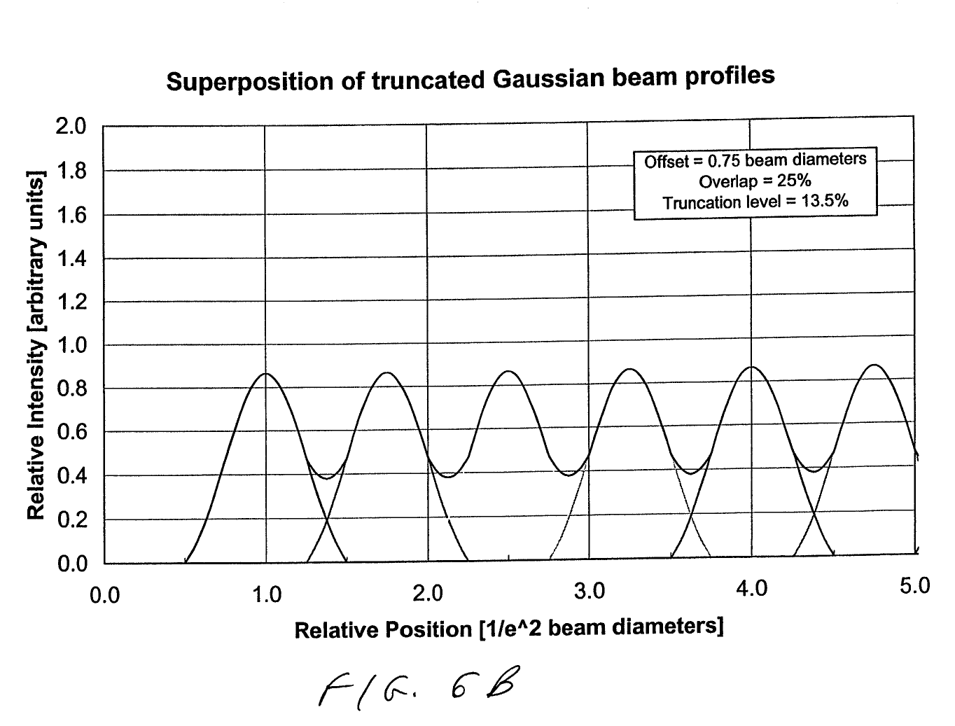

FIG. 1A shows an embodiment of the present invention for forming smooth microchannels of a microfluidic device. Laser 10 emits laser pulses. Preferably laser 10 is a solid-sate laser that emits light in the ultraviolet range. More preferably laser 10 is an AVIA™ yttrium orthovanadate laser manufactured by Coherent. The AVIA™ neodymium-doped laser can be made to emit light pulses at 355 nm, 266 nm, or 213 nm at a range of pulse repetition rates. Controller 20 typically includes a microcontroller or microprocessor and functions to coordinate the firing of the laser 10 and the operation of the galvanometric scanner 30.

Galvanometric scanner 30 includes associated scanning mirrors, which scanning mirrors direct the laser beam from laser 10 onto the target plane 60. Controller 20 applies a series of voltages to the galvanometric scanner 30. These applied voltages cause the scanning mirrors to move in small increments so as to correspondingly redirect the laser beam and move the location of the beam spot on the target plane 60. Such galvanometric scanners are well-known in the art of laser scanning. Suitable galvanometric scanners may be purchased from GSI Lumonics or SCANLAB. Flat field objective lens 50 is a focusing lens that is corrected for field curvature image.

According to the present invention, there is a key relationship between obtaining smooth microchannels and the level of pulse overlap and line overlap used in scanning the laser 10 along the target plane 60. The reason for this is that laser pulses do not generally have a “top-hat” or uniform spatial intensity profile. Typically a laser beam pulse has a Gaussian spatial intensity profile in the plane perpendicular to the propagation of the laser beam. As a result, a high degree of both pulse overlap and line overlap as defined herein are needed in order to smooth out the exposure of the substrate surface to laser energy. In order to form microchannels with smooth bottoms and walls using such Gaussian laser pulses, then, it is highly desirable to employ a high degree of both pulse overlap and line overlap.

The intensity distribution associated with a Gaussian laser pulse decreases as EXP(−kx²) as one moves away from the center of the pulse profile in direction x, where k is a scaling constant. If the Gaussian pulse has a circular symmetry, the pulse fluence distribution can be represented as follows:

F(r)=F₀EXP(−kr²)

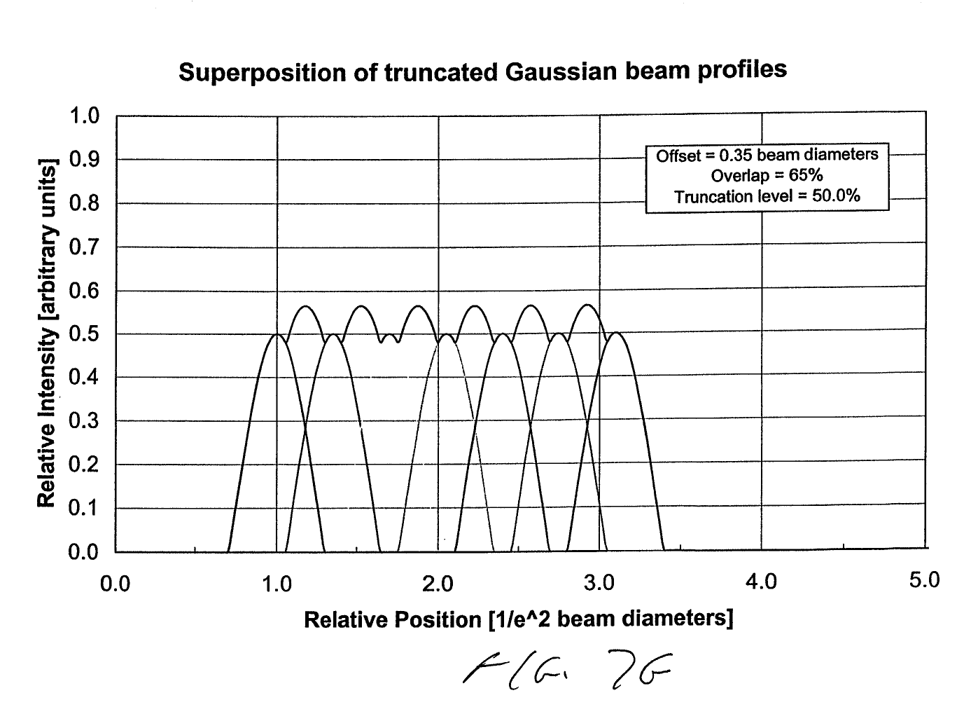

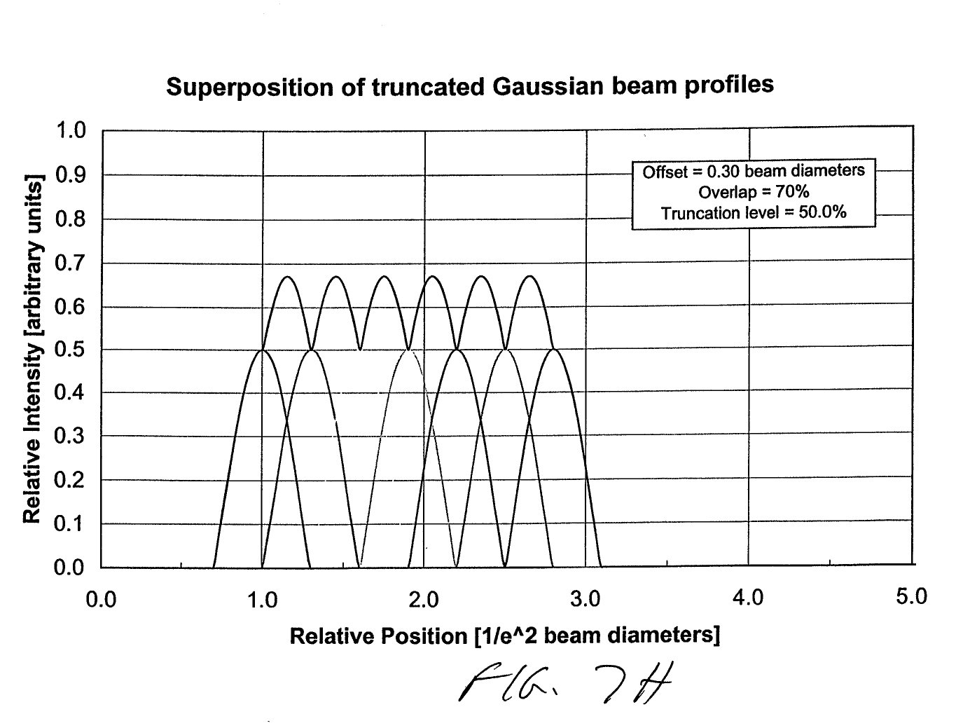

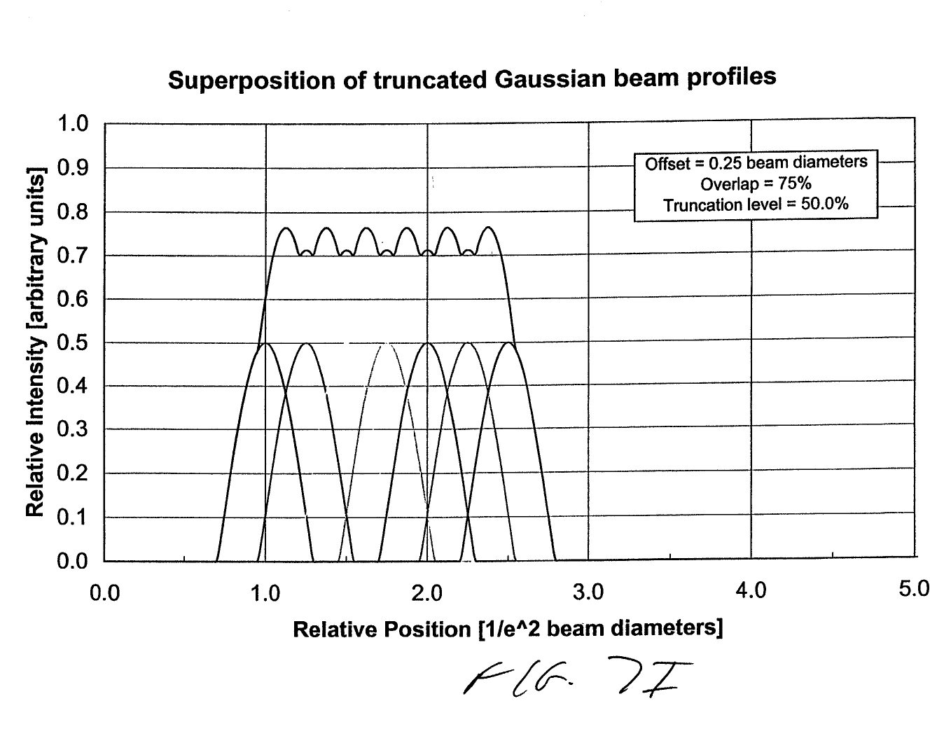

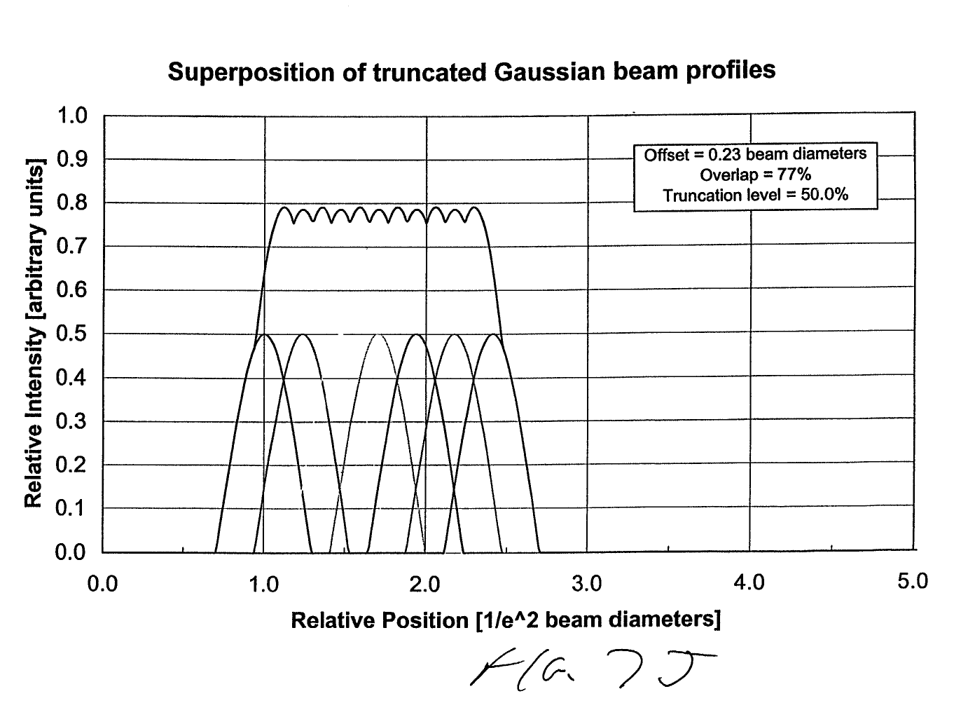

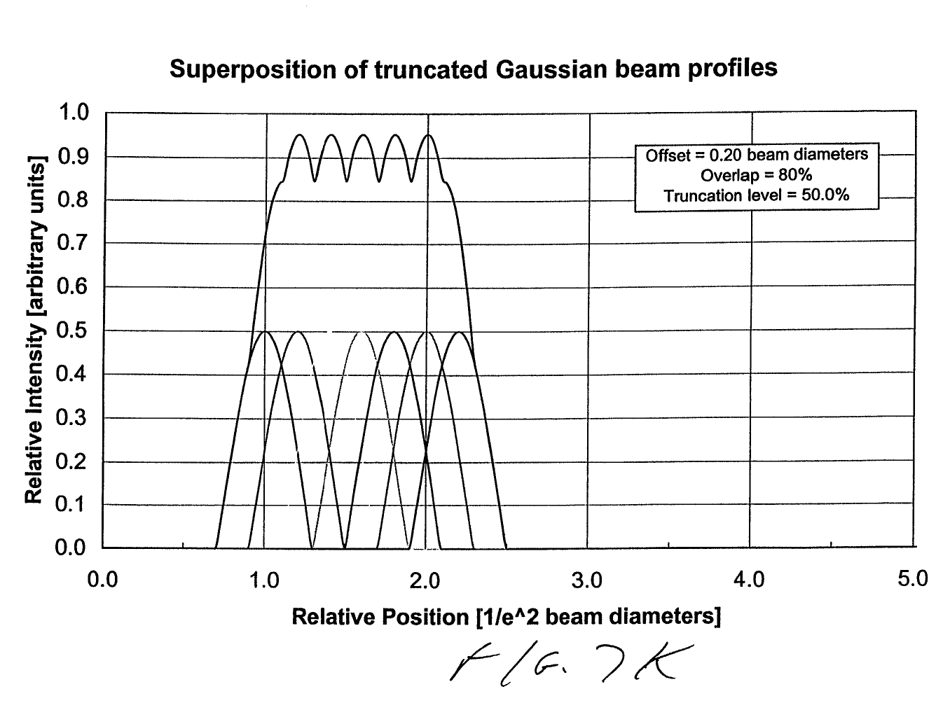

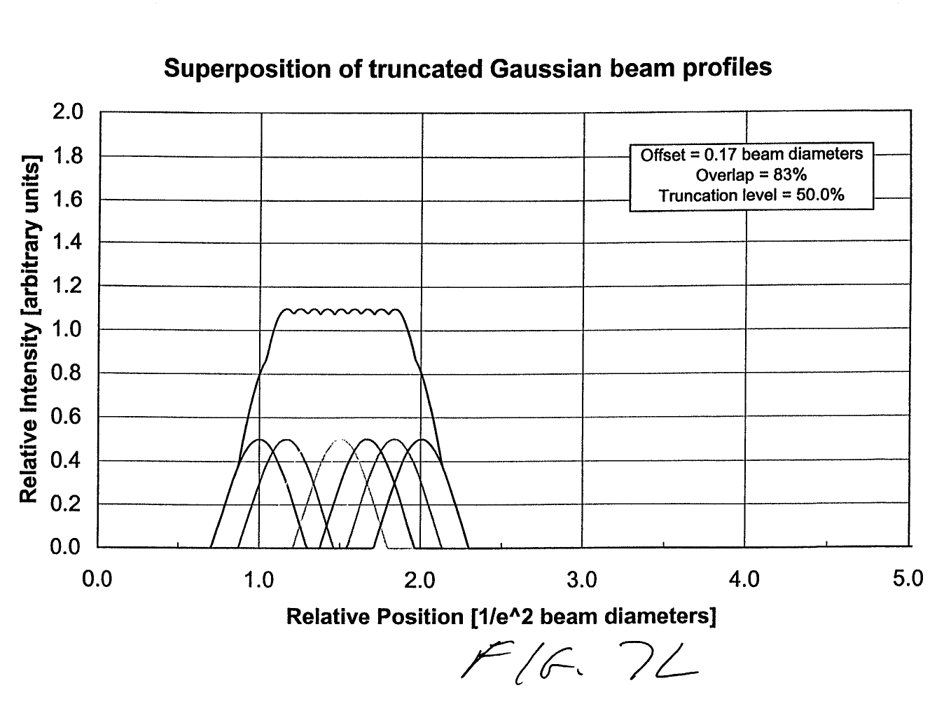

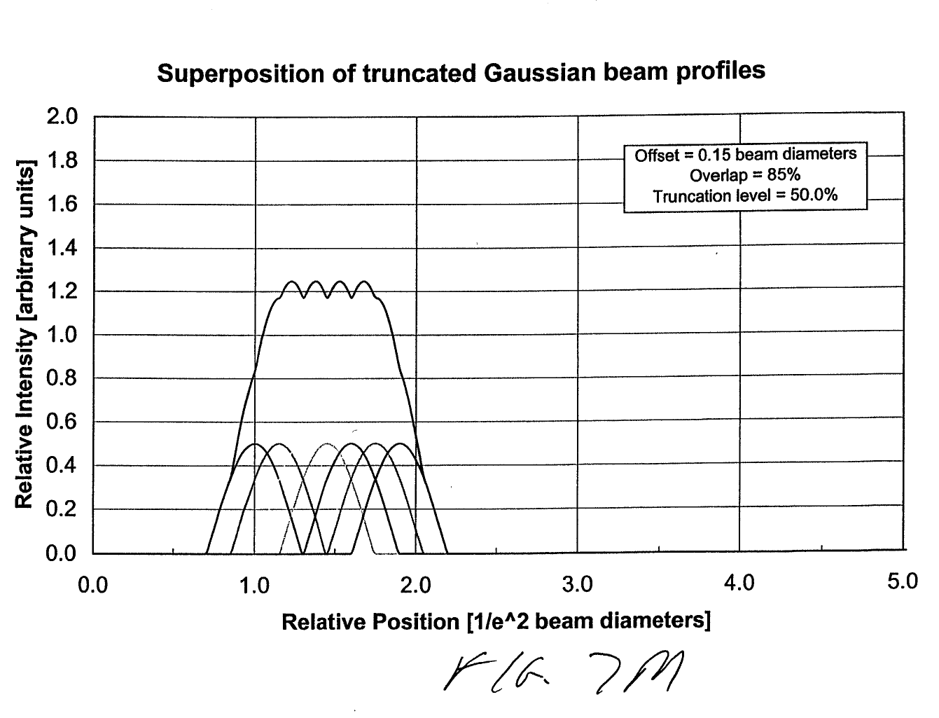

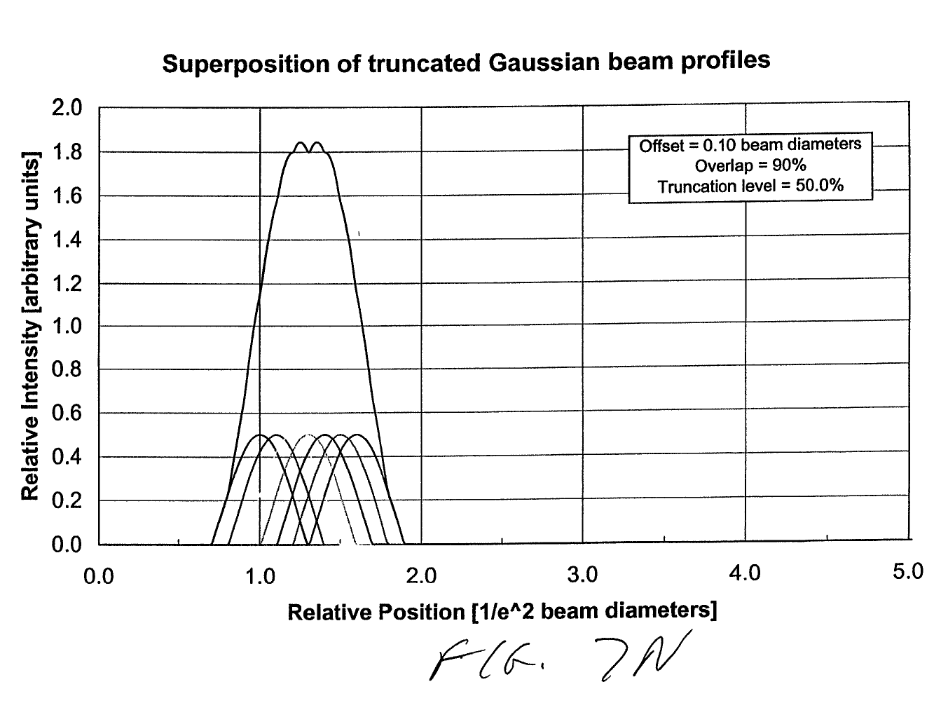

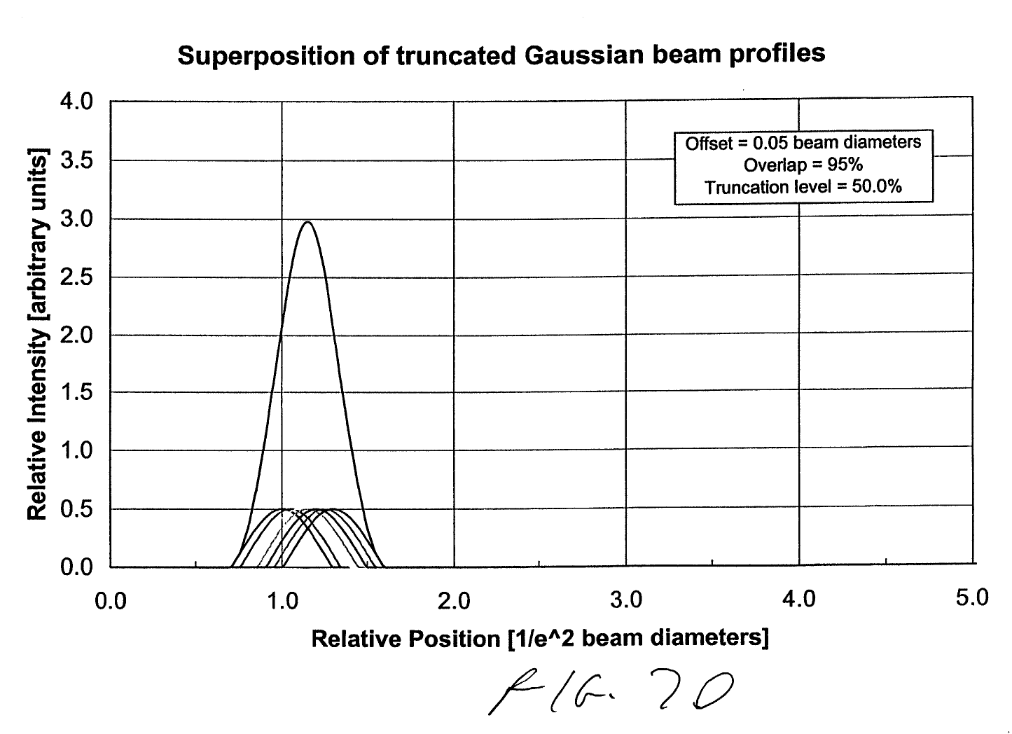

Here r is the distance from the center of the pulse profile and F₀ is the value for the fluence at the center. (The “fluence” of a laser pulse may be defined as the energy associated with the pulse divided by the beam spot area, which is also the same as the average beam power divided by the product of the beam spot area and the pulse repetition rate.) Typically the spot size of a laser pulse profile in a given direction may be taken as twice the distance from the pulse profile center at which the fluence value is 1/e² (13.5%) of the fluence value at the center. (This size is 2(2/k)^{½} for a pulse with a circular Gaussian profile as given above.) Where the pulse fluence is of the same order as the ablation threshold for the substrate being treated, this definition may not be appropriate however. (As used herein, “ablation threshold” may be defined as the minimum fluence value needed to initiate ablation in a given substrate material.) In such cases, 1/e²times the peak fluence value may be less than the ablation threshold, meaning that the effective “spot size” is smaller than suggested by this convention. This situation is illustrated in FIG. 4 where curve 430 represents the spatial fluence distribution of the laser pulse, 420 represents the fluence ablation threshold for the substrate, and distance W₁ is the 1/e² diameter of the pulse. In such cases a more appropriate measure of the spot size is the distance over which the fluence values are above the ablation threshold. In FIG. 4 this distance is labeled as W₂. As used herein, “effective spot size” is defined as the lesser of the 1/e² size and the distance over which the fluence values are above the ablation threshold of the substrate being treated.

As used herein, the percentage pulse overlap between successive focal spots along a line-scan may be defined by the formula:

PO=100[1−(SR÷PR)(1/ESZ)] if (SR÷PR)(1/ESZ)≦1; 0 otherwise.

Here PO is the pulse overlap and is a positive percentage ranging from 0 to 100; SR is the instantaneous scan rate along a line-scan of pulses in the target plane measured in mm/sec; PR is the pulse repetition rate in Hz; and ESZ is the effective spot size in mm. The ratio of the scan rate SR to the pulse repetition rate PR gives the distance that the focal spot position moves along a line-scan per unit time divided by the number of pulses fired per unit time. In other words, SR/PR is the incremental distance DELTAₚᵤₗₛₑ that the focal spot position moves between successive pulses along a line-scan. So the pulse overlap is also given by the formula:

PO=100[1−DELTAₚᵤₗₛₑ/ESZ] if DELTAₚᵤₗₛₑ/ESZ≦1; 0 otherwise.

Line overlap is similar to pulse overlap but relates to the overlap between separate adjacent line-scans of pulses rather than the overlap between individual pulses in a given line-scan. The percentage line overlap between line-scans of laser pulses may be defined by the formula:

LO=100 [1−DELTAₗᵢₙₑ/ESZ] if DELTAₗᵢₙₑ/ESZ≦1; 0 otherwise.

Here LO is the line overlap and is a positive percentage ranging from 0 to 100; DELTAₗᵢₙₑ is the incremental distance that the scanner moves when it initiates a new line-scan of pulses in the target plane measured in mm; and ESZ is the effective spot size in mm.

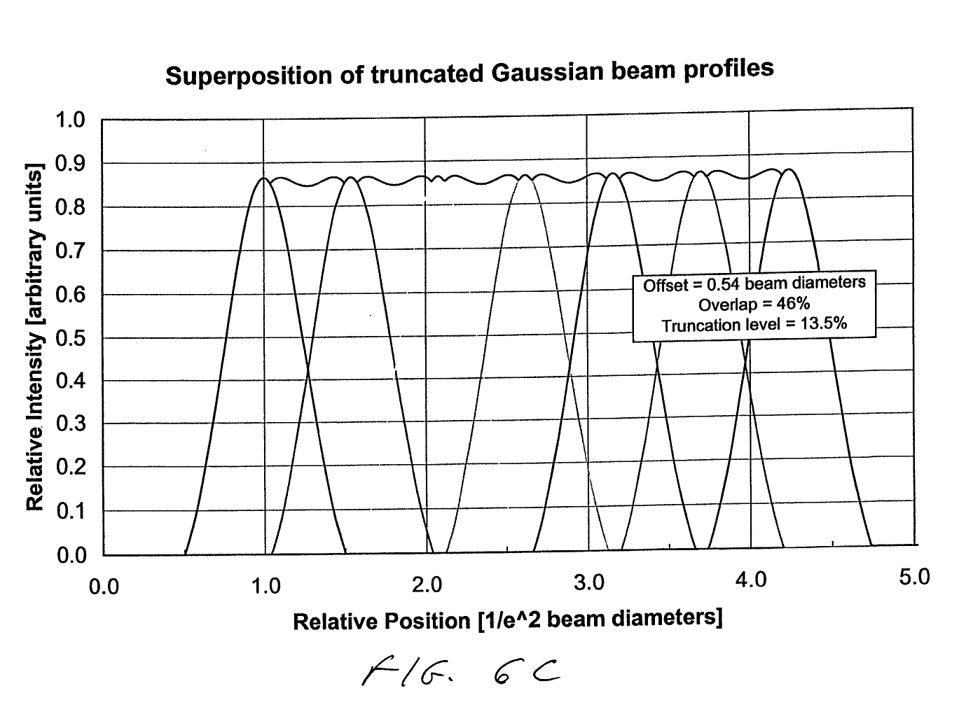

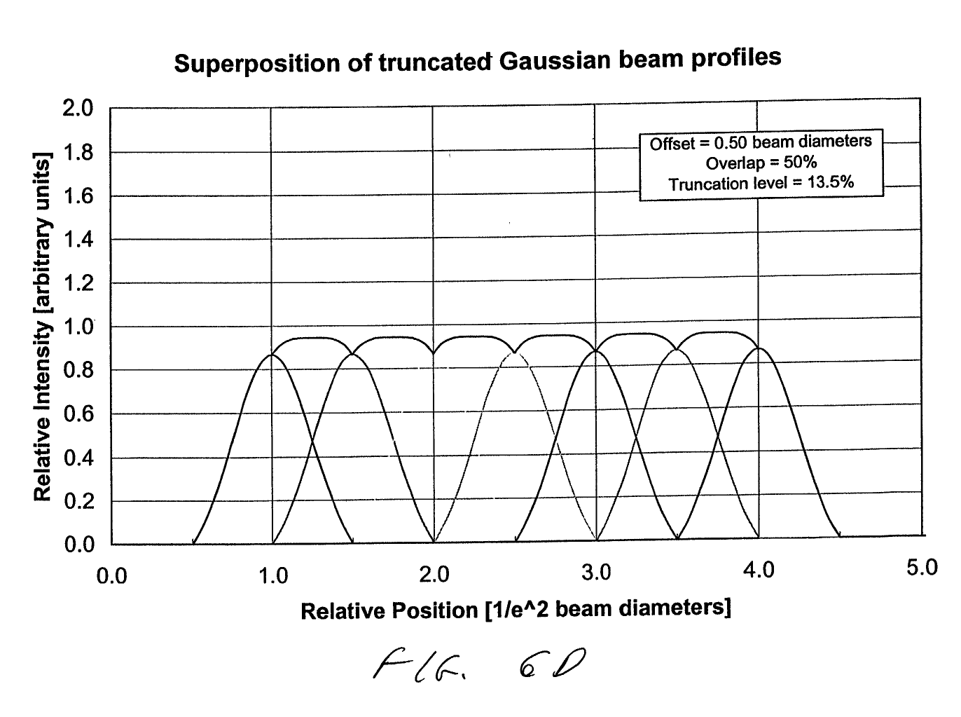

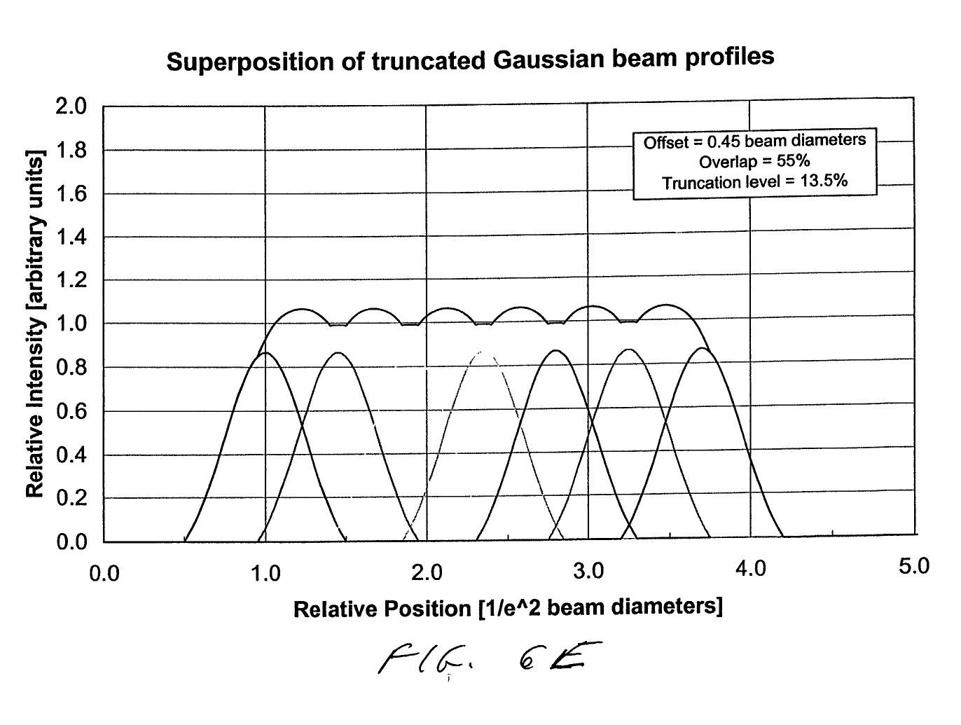

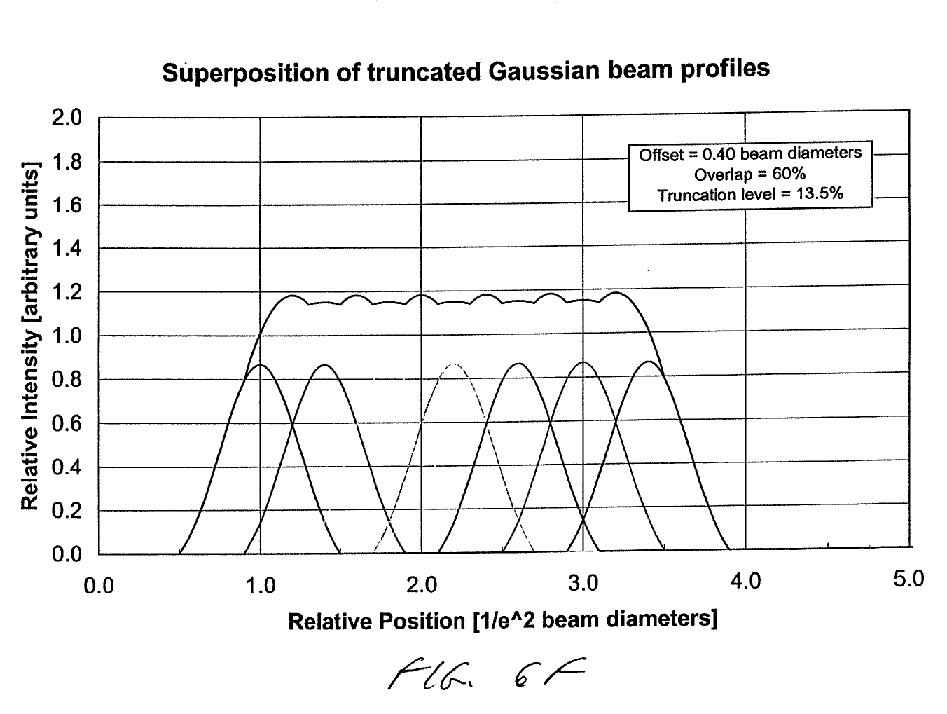

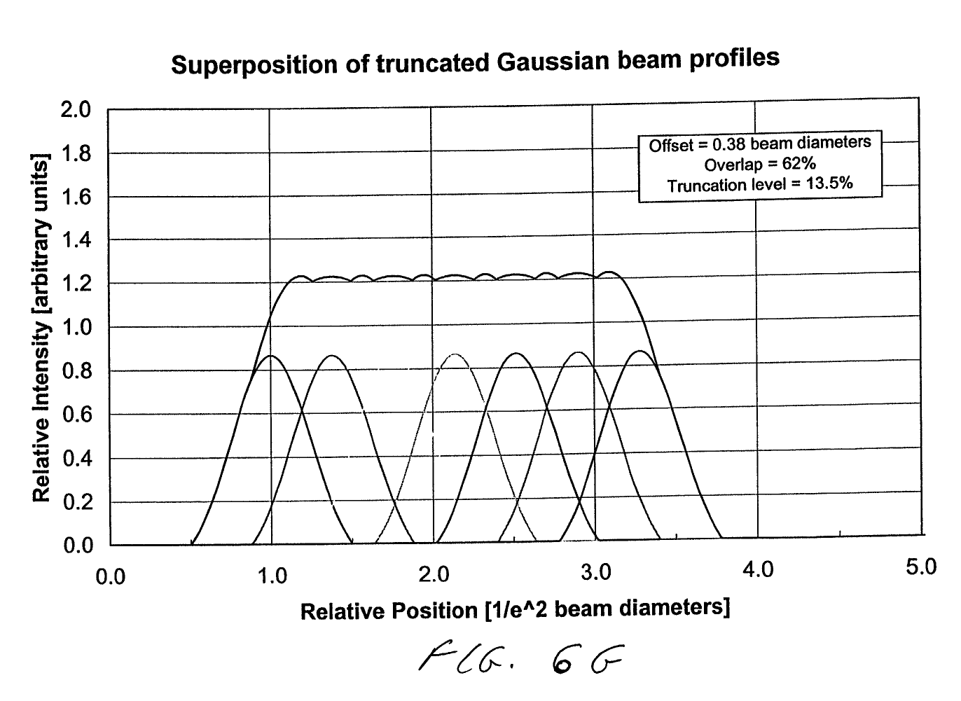

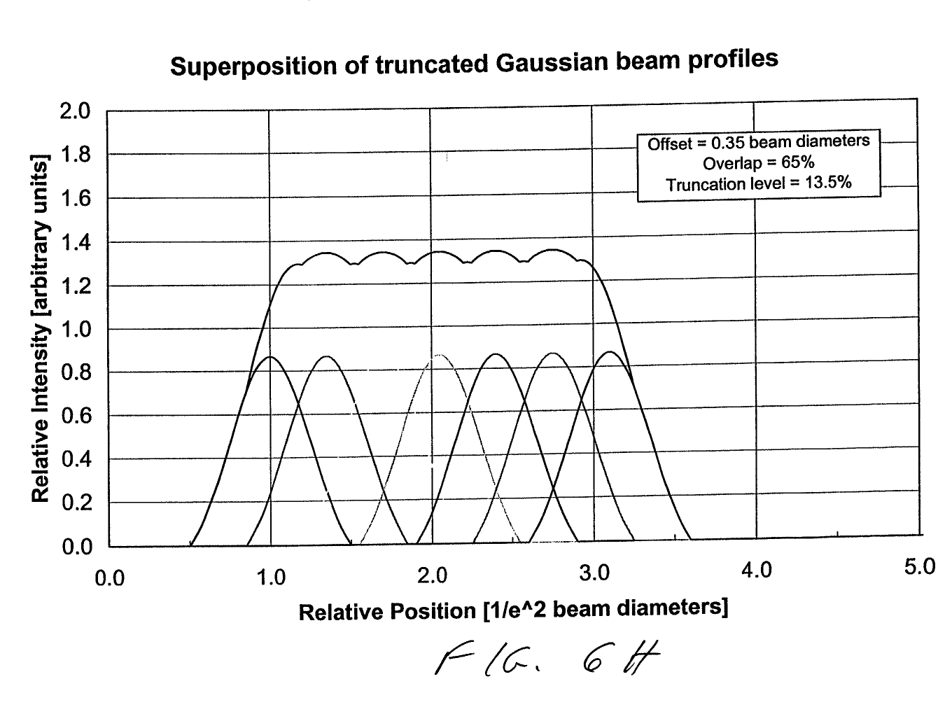

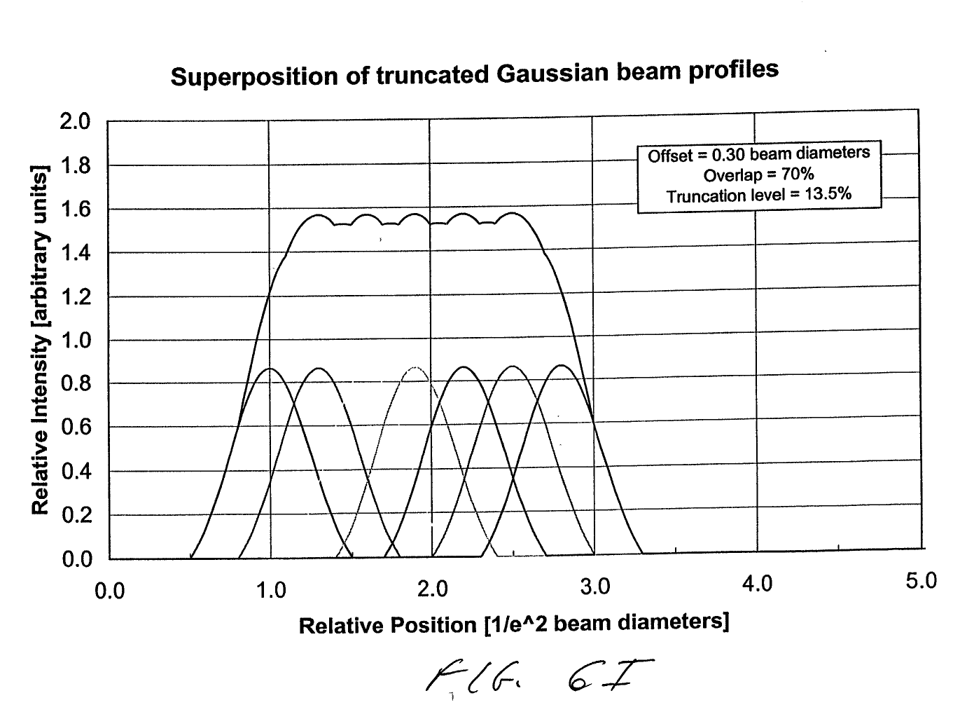

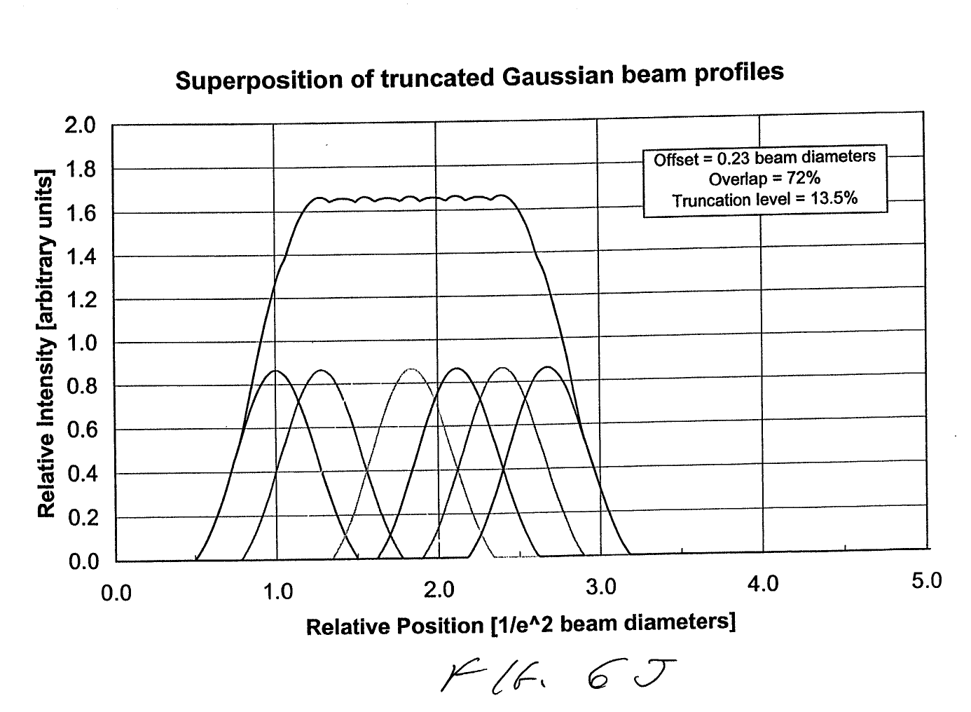

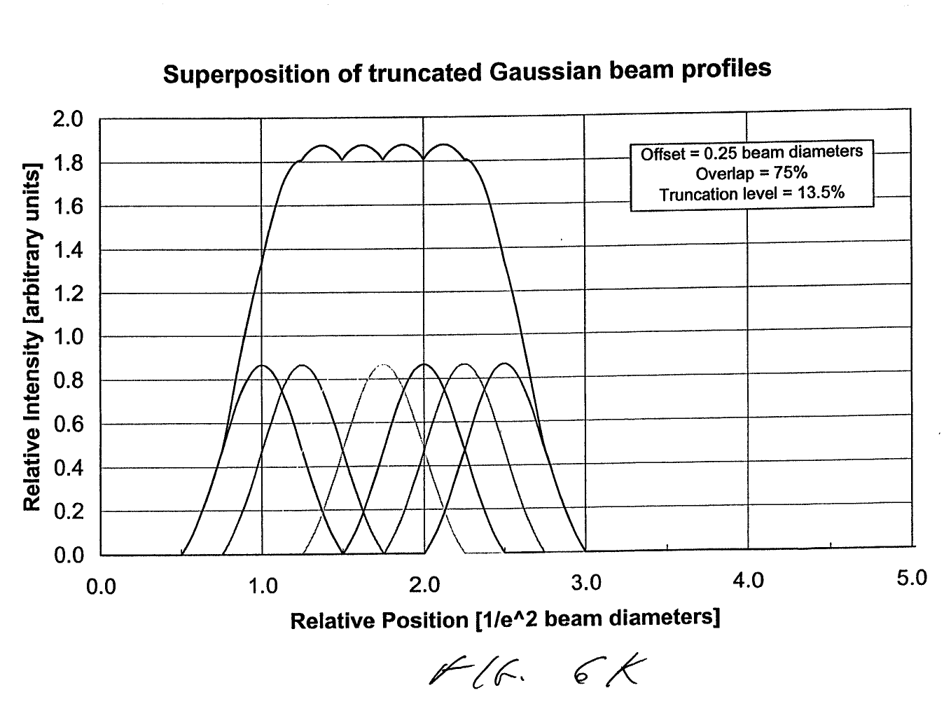

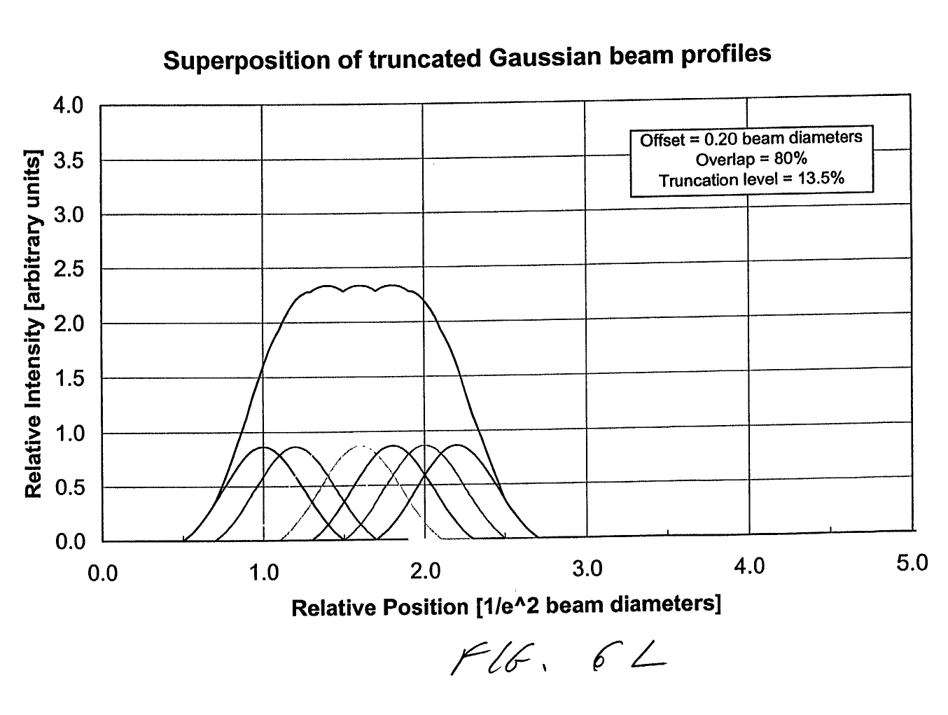

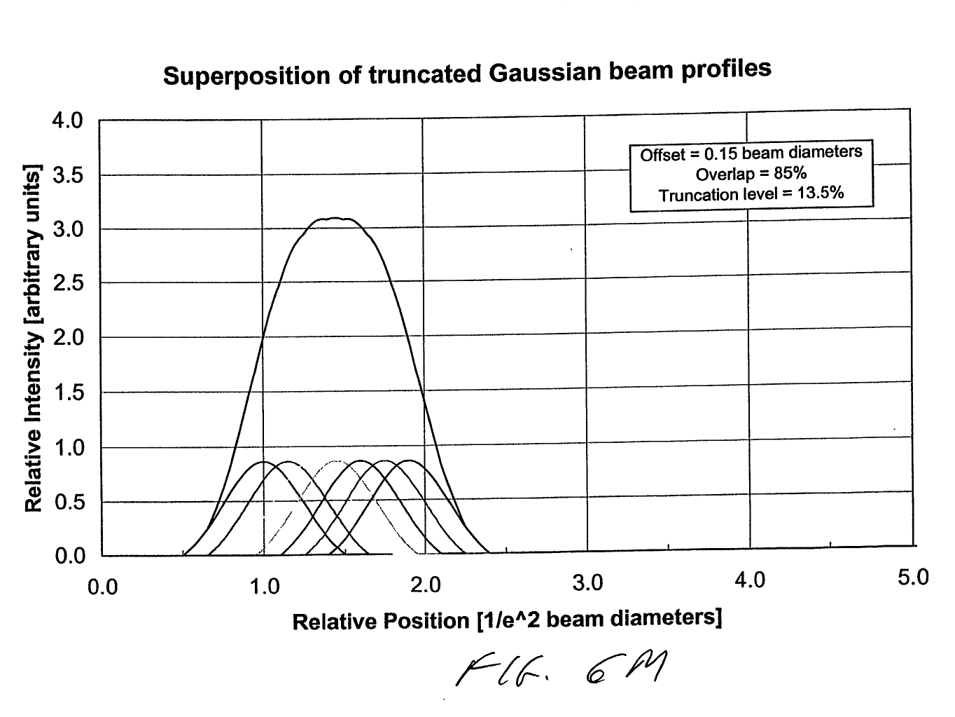

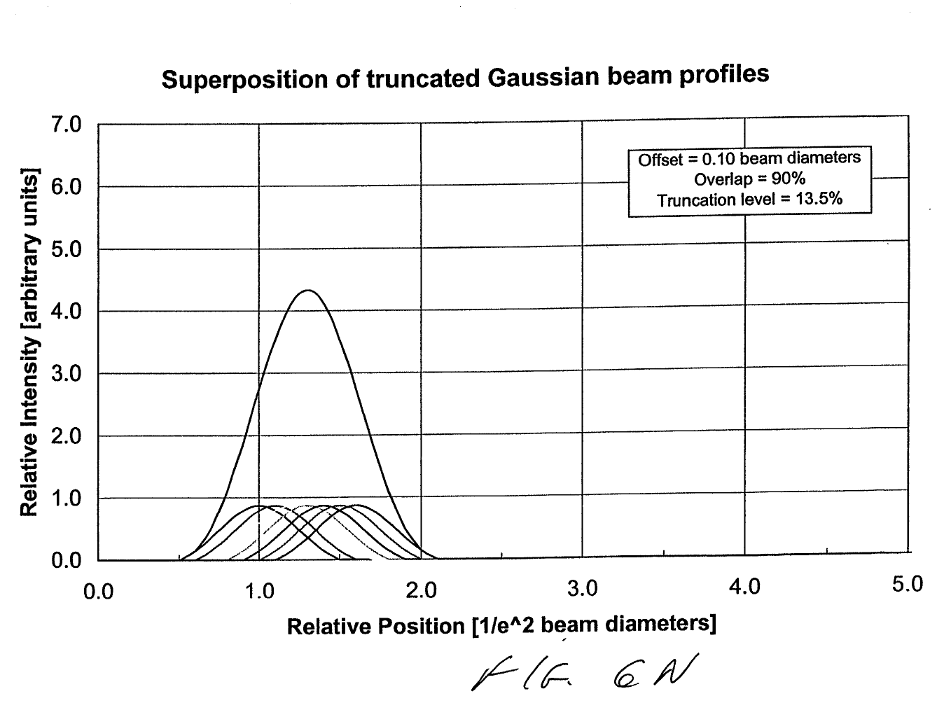

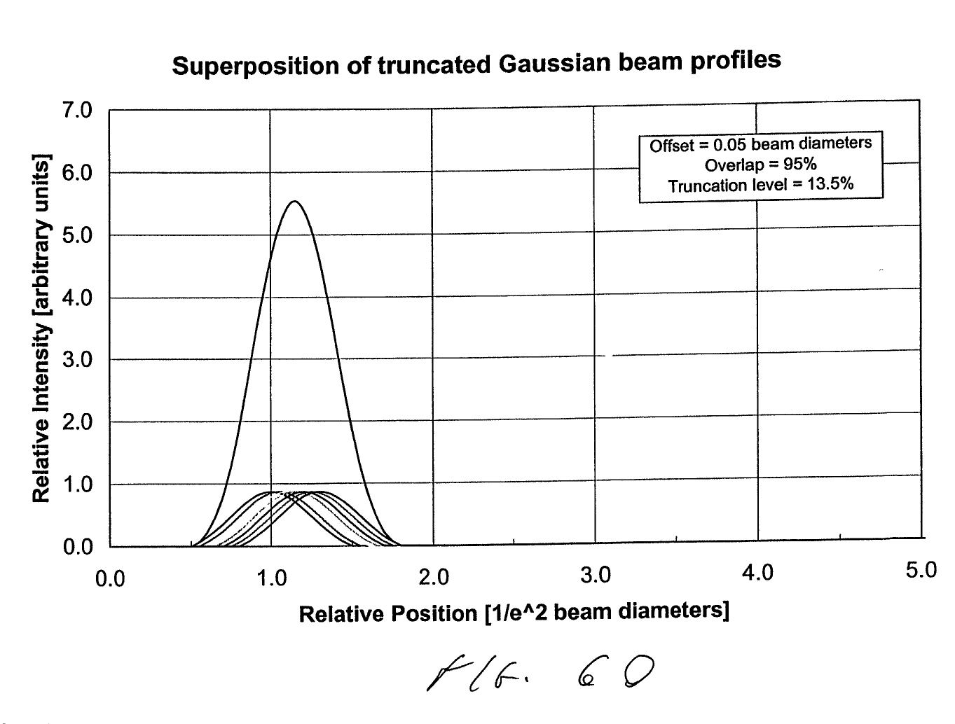

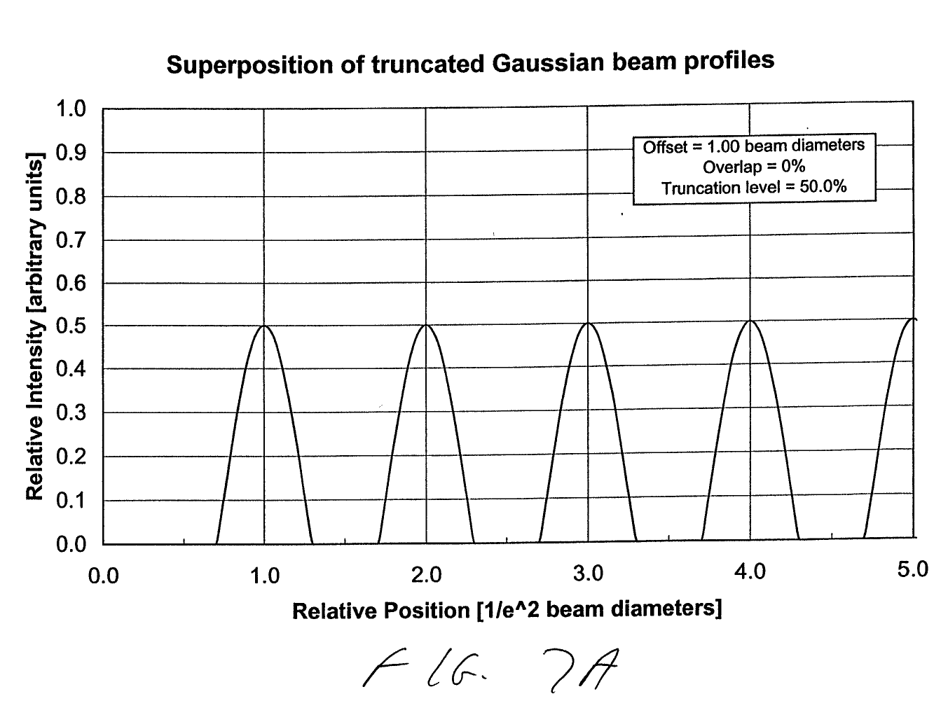

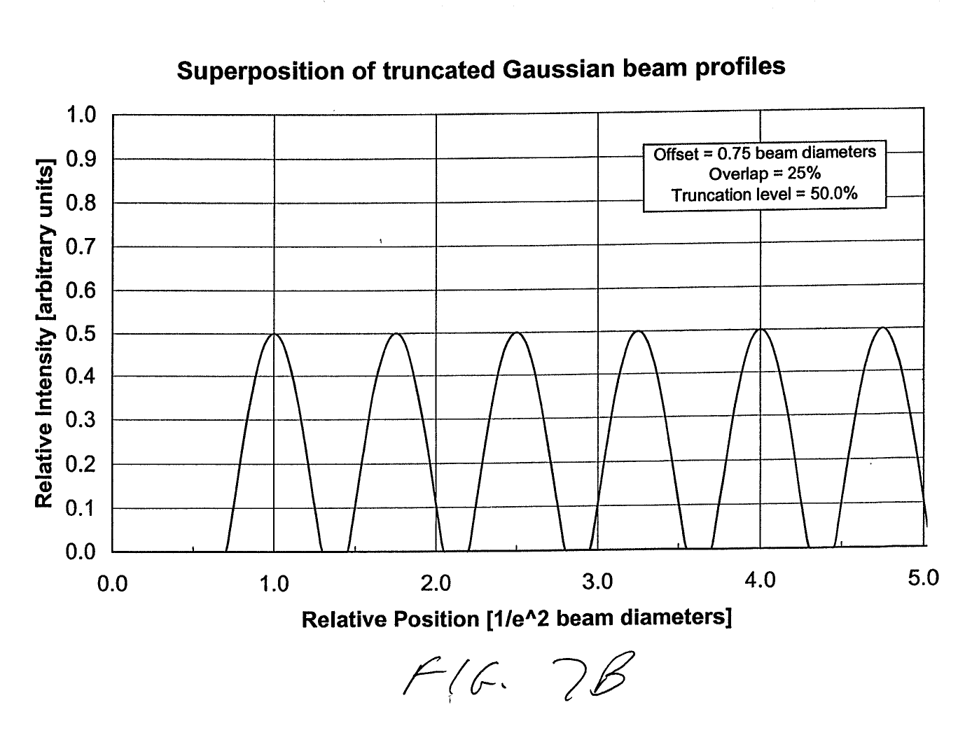

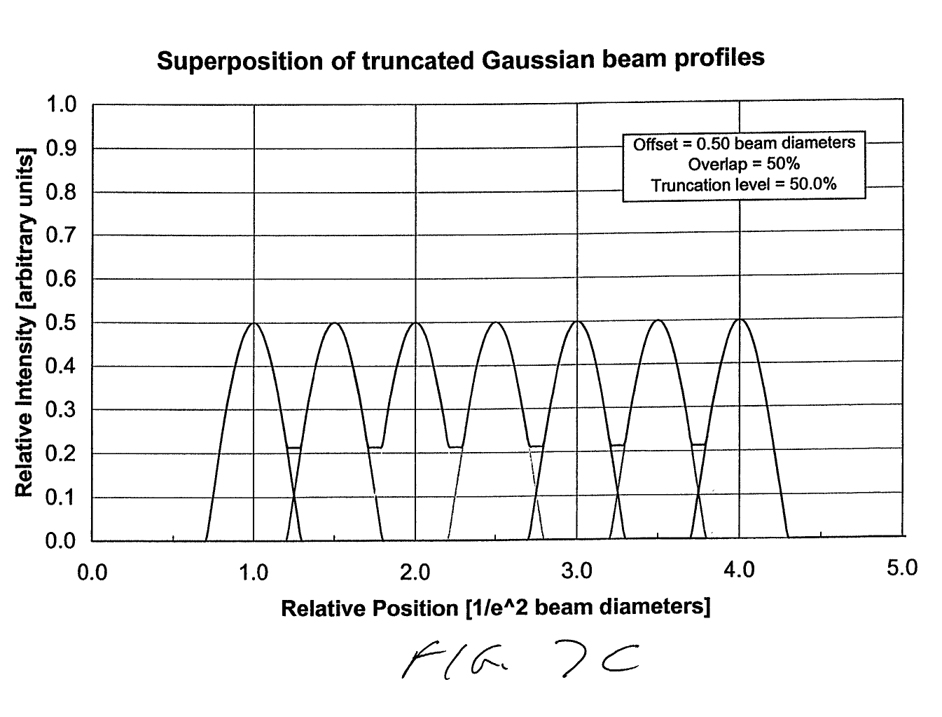

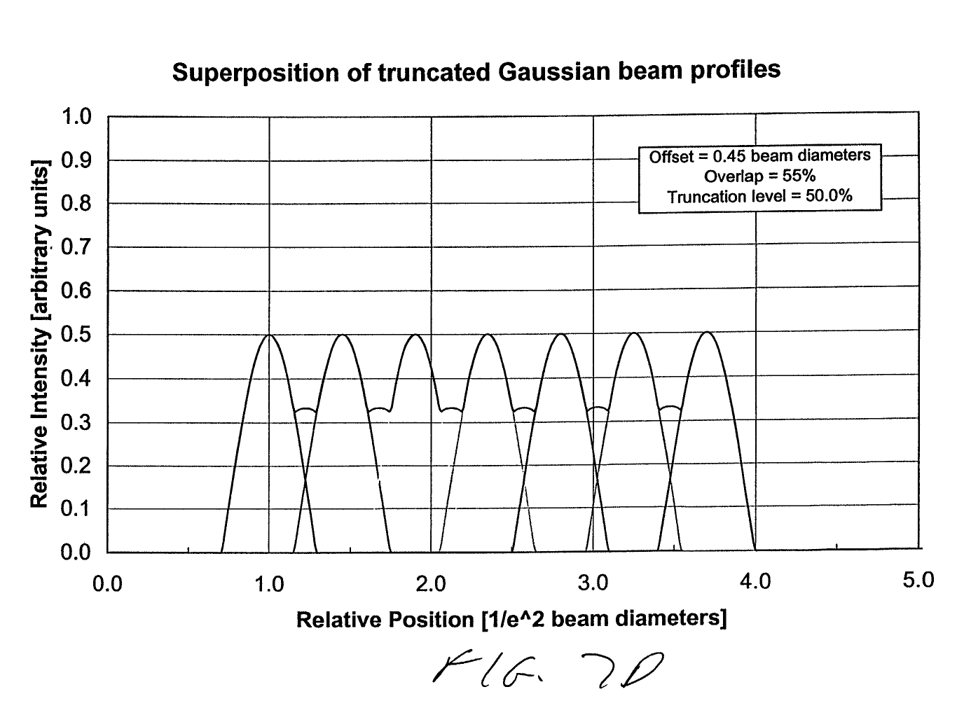

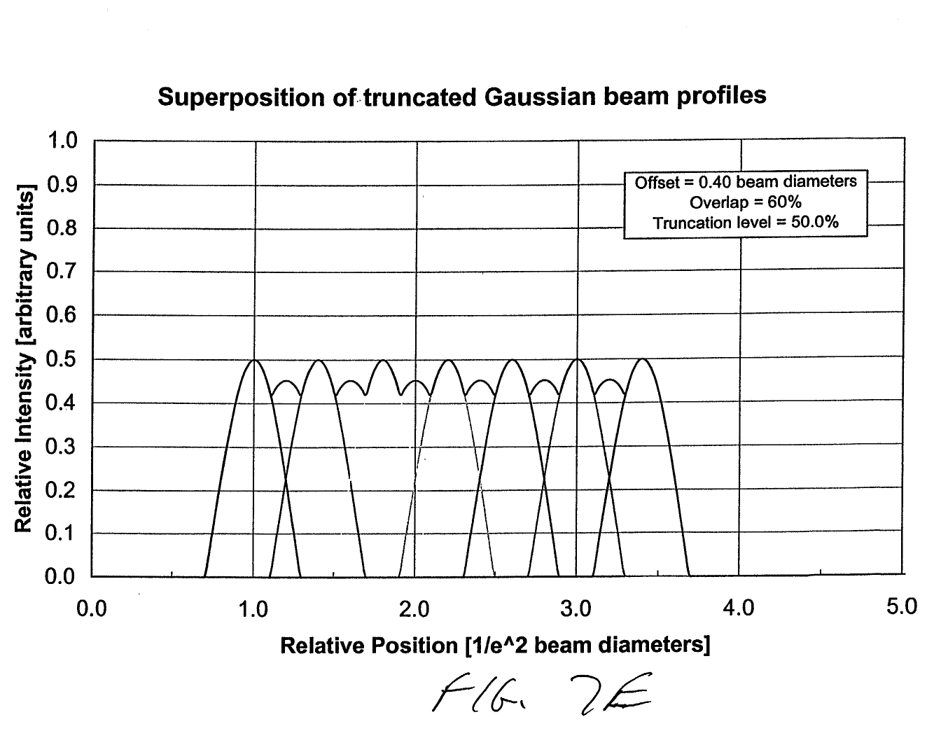

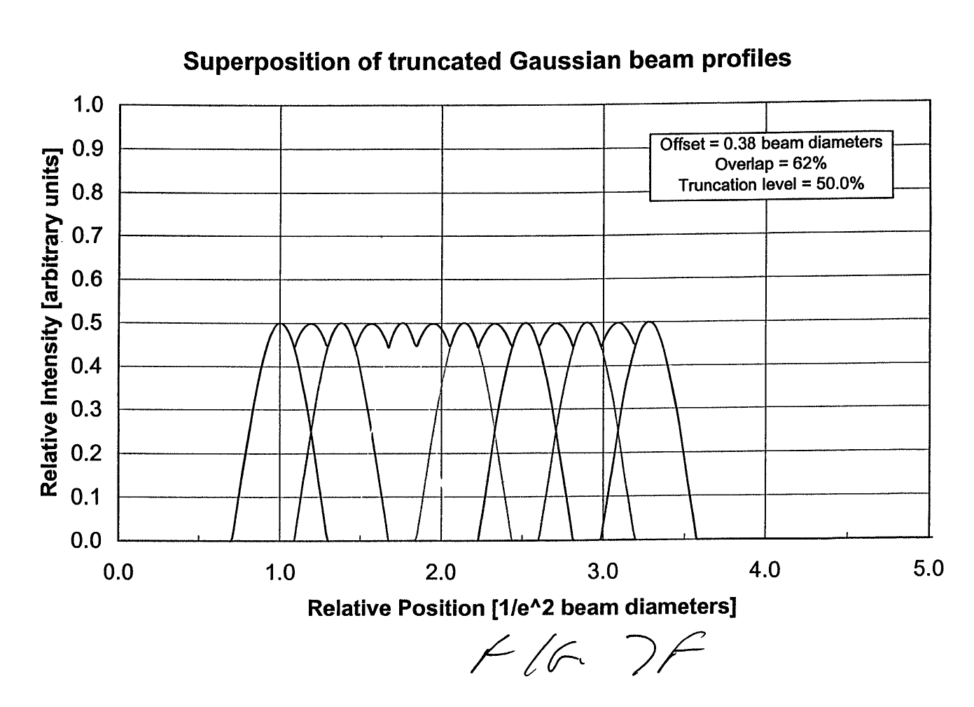

FIGS. 2 and 3 illustrate these concepts. FIG. 2 shows both pulse overlap along five different line-scans of laser pulses that progressed in direction X and line overlap among the five line-scans which incremented in direction Y. Distance CW represents the width of the microchannel being ablated. As FIG. 2 shows, when overlap is present, multiple laser pulses can contribute to ablation at a single location in the target plane. FIG. 3 shows pulse overlap as a function of effective spot size for a line-scan of a laser where the pulse repetition rate is fixed at 20 kHz and the scan rate is a constant 200 mm/sec. The effective spot size is given in microns and is the only dependent variable. As FIG. 3 shows, the pulse overlap increases with effective spot size.

FIGS. 5A-5M, 6A-6O, and 7A-7O are graphs showing a distribution for the summed or total intensity of light received as a function of position along a line-scan. In each graph the smaller distributions show the spatial intensity distributions for each of the individual pulses of the line scan that were summed to produce the total light intensity distribution graph. The percentage pulse overlap for these various graphs varies from 0% to 95%.

In FIGS. 6A-6O, the spatial intensity distributions for each pulse in the line-scans that were summed to produce these graphs were truncated or set to zero at the 13.5% or 1/e² point (i.e., the abscissa was moved and the regions of the intensity curves corresponding to intensities of 13.5% or less of the peak were reset to zero). This was done to simulate the phenomenon of fluence ablation threshold, where a minimum fluence value is needed in order to initiate ablation in a given substrate material. Similarly, in FIGS. 7A-7O, the spatial intensity distributions for each pulse in the line-scans that were summed to produce these graphs were truncated or set to zero at the 50% point.

As these figures show, as the overlap percentage is varied for each of the three selected truncation levels (0%, 13.5%, and 50%) “resonances” appear corresponding to particularly smooth total intensity distribution curves. A total intensity distribution curve with a smooth “top” corresponds to the formation of a microchannel with a smooth bottom. FIG. 5E shows one such resonance occurring at or near an overlap percentage of 55% where truncation is set a 0%. FIG. 6C shows another resonance at or near an overlap percentage of 46% where truncation is set at a level of 13.5%. FIGS. 6G and 6J show two more resonances at or near overlap percentages of 62% and 72%, respectively, again where truncation is also set at a level of 13.5%. Similarly, FIGS. 7F, 7J, and 7L, show three more such resonances at or near overlap percentages of 62%, 77%, and 83%, respectively, all where truncation is set at a level of 50%.

Although these figures have been nominally described as graphing the effects of varying the percentage of pulse overlap, these same figures could also be interpreted as graphing the effects of varying the percentage of adjacent line overlap, which is a closely similar phenomenon to pulse overlap.

In order to form microchannels with especially smooth bottoms, pulse overlap and line overlap values must be selected accordingly. As the graphs of the figures show, resonances occur for certain choices of pulse and line overlap values that produce particularly smooth summed intensity distribution curves. Ablation using overlap values corresponding to such resonances creates microchannels with especially smooth bottoms. Accordingly, during laser ablation, it is highly desirable to select levels of both pulse overlap and line overlap that enhance the smoothness of the surface of the resulting microchannel.

FIG. 1B shows an alternative embodiment of the present invention. This embodiment is quite similar to the embodiment shown in FIG. 1A except for the addition of a beam homogenizer 40. The beam homogenizer 40 functions to transform the Gaussian spatial intensity profile of the laser pulses emitted by laser 10 to an equalized or uniform spatial intensity profile that has a rectangular rather than Gaussian shape. Because such equalized spatial profiles have a rectangular shape, they are often referred to a “flat top” or “top hat” profiles. Several suitable techniques are known for transforming laser pulses having a Gaussian profile into pulses having a flat top profile. Such a transformation of a laser beam spatial profile to a flat top profile may be referred to as “homogenizing” the beam profile, and this is the intended meaning of the word “homogenize” as used herein. (When a laser pulse spatial profile is described as “rectangular” rather than Gaussian, this does not mean that the spot made by the laser on the target plane is itself rectangular but rather that the curve describing the intensity profile along a given dimension perpendicular to the direction of propagation is rectangular in shape rather than Gaussian. However, the same techniques that homogenize laser beam spatial profiles can also be used to alter the geometry of the laser spot itself such as from circular or elliptical to square or rectangular.) When pulses having such flat top profiles are employed, there is much less need to employ a high pulse overlap and line overlap as a means of smoothing out the exposure of the substrate surface to laser energy. Accordingly, laser pulses having flat top profiles are particularly suited to forming microchannels with smooth bottoms and walls.

One simple homogenizing technique is to spatially truncate the Gaussian laser pulses by passing them through an aperture sized so as to transmit a central portion of the Gaussian while stopping the outer side portions. Other techniques for flattening the beam profile employ more complex diffractive or refractive systems. U.S. Pat. No. 4,895,790, hereby incorporated by reference in its entirety, discloses the homogenizing of laser pulse profiles using multiple diffractive masks as well as a method for making such diffractive masks. U.S. Pat. Nos. 5,148,317, hereby incorporated by reference in its entirety along with U.S. Pat. No. 4,846,552, discloses the use of a convex-plano lens having a diffractive mask element etched onto the piano side of the lens in order to both homogenize the spatial profile of a laser beam and to collimate the beam.

The scope of the present invention is meant to be that set forth in the claims that follow and equivalents thereof, and is not limited to any of the specific embodiments described above.

What is claimed is:

1. A method of forming a microchannel on a substrate comprising the steps of:
generating a pulsed laser beam including a sequence of laser pulses;
focusing said laser beam onto the surface of said substrate so that said sequence of laser pulses forms a corresponding sequence of images on said surface;
scanning said laser beam along the surface of said substrate so as to form one or more linescans on said surface; and
controlling the generating and scanning of said laser beam such that said linescans and said images overlap to an extent selected such that smoothness of the surface of said microchannel is enhanced.

2. A method as recited in claim 1 wherein said generating step includes using a solid-state laser that emits light in the ultraviolet range.

3. A method as recited in claim 1 wherein said scanning step includes using a galvanometric scanner.

4. A method as recited in claim 1 wherein said focusing step includes using a flat field objective lens.

5. A method as recited in claim 1 wherein said generating step includes using a solid-state laser that emits light in the ultraviolet and further wherein said scanning step includes using a galvanometric scanner.

6. A method as recited in any of claims 1, 2, 3, 4, or 5 wherein both the pulse overlap and the linescan overlap employed are about 50% or greater.

7. A method as recited in any of claims 1, 2, 3, 4, or 5 wherein both the pulse overlap and the linescan overlap employed are about 60% or greater.

8. A method as recited in any of claims 1, 2, 3, 4, or 5 wherein both the pulse overlap and the linescan overlap employed are about 70% or greater.

9. A method as recited in claim 1 wherein said pulses in said sequence thereof have a gaussian spatial intensity distribution.

10. A method as recited in claim 1 further comprising the step of homogenizing said laser beam before said laser beam reaches said substrate so that said pulses in said sequence thereof have a generally rectangular spatial intensity distribution.

11. A method of forming a microchannel on a substrate comprising the steps of:
generating a pulsed laser beam including a sequence of laser pulses having a first spatial intensity distribution;
homogenizing said laser beam so that said first spatial intensity distribution of said sequence of laser pulses is changed to a second intensity distribution having a generally flat-topped spatial profile;
focusing said laser beam onto the surface of said substrate so that said sequence of laser pulses forms a corresponding sequence of images on said surface;
scanning said laser beam along the surface of said substrate so as to form one or more linescans on said surface; and
controlling the generating and scanning of said laser beam so as to form said microchannel on said substrate.

12. A method as recited in claim 11 wherein said generating step includes using a solid-state laser that emits light in the ultraviolet range.

13. A method as recited in claim 11 wherein said scanning step includes using a galvanometric scanner.

14. A method as recited in claim 11 wherein said homogenizing step includes passing said laser beam through a diffractive element.

15. A method as recited in claim 11 wherein said focusing step includes using a flat field objective lens.

16. A method as recited in claim 11 wherein said generating step includes using a solid-state laser that emits light in the ultraviolet and further wherein said scanning step includes using a galvanometric scanner.

17. A method as recited in claim 11 wherein said generating step includes using a solid-state laser that emits light in the ultraviolet range and further wherein said homogenizing step includes passing said laser beam through a diffractive element.

18. A method as recited in claim 17 wherein said scanning step includes using a galvanometric scanner.

19. A method as recited in claim 11 wherein said first intensity distribution is about gaussian.

20. A method as recited in claim 11 wherein said second intensity distribution is generally rectangular.
